(19) United States
(12) Patent Application Publication
(10) Pub. No.: US 2020/0203951 A1
(43) Pub. Date: Jun. 25, 2020

(54) TRANSACTIVE MECHANISM TO ENGAGE INVERTERS FOR REACTIVE POWER SUPPORT

(71) Applicant: Battelle Memorial Institute, Richland, WA (US)

(72) Inventors: Md Jan E Alam, Richland, WA (US); Abhishek Somani, Richland, WA (US); Ronald B. Melton, Richland, WA (US)

(73) Assignee: Battelle Memorial Institute, Richland, WA (US)

(21) Appl. No.: 16/226,481

(22) Filed: Dec. 19, 2018

(51) Int. Cl. H02J 3/18; H02J 13/00; H02J 3/38; G05B 19/042; G06Q 50/06

(52) U.S. Cl. CPC H02J 3/18; H02J 13/0017; H02J 2003/007; G05B 19/042; G06Q 50/06; H02J 3/383

(57) ABSTRACT

Apparatus and methods are disclosed for performing voltage management in a power grid by engaging distributed energy resources (DERs) to source or sink reactive power. An administrator can produce a demand curve relating demanded quantities of reactive power for an upcoming interval to corresponding marginal prices the utility will pay for the quantities. Controllers of one or more DERs electrically coupled to the power grid can produce a supply curve relating offered quantities of reactive power for the upcoming interval to marginal prices the DER will accept to supply the quantities. A coordinator controller can determine a clearing price and quantity for reactive power for the upcoming interval based on the demand and supply curves and cause the one or more DERs to collectively dispatch the clearing quantity of reactive power to the power grid during the upcoming interval.

### ACKNOWLEDGMENT OF GOVERNMENT SUPPORT

This disclosure was made with government support under Contract DE-AC05-76RL01830 awarded by the U.S. Department of Energy. The government has certain rights in the invention.

### BACKGROUND

During certain conditions, achieving a desired voltage profile along a feeder of a power grid may require sourcing reactive power to the feeder or sinking reactive power from the feeder. In some cases, capacitor banks coupled to a feeder are switched in and out to perform this function. However, a capacitor bank may be rated for only a certain number of switching operations over its lifetime. Also, capacitor banks create step changes in voltage along a feeder due to their switched operation and may not always achieve a desired effect. Static VAR Compensators (SVC) are utilized in some cases for finer quality voltage control. However, their cost needs to be justified against the benefit of voltage control granularity achieved. Other disadvantages associated with the use of switching capacitor banks to regulate voltage include the introduction of high current transients.

Inverters can also source or sink reactive power. Increasing numbers of utility customers install rooftop photovoltaic (PV) systems, resulting in a high penetration of distributed energy resources (DERs) in many power grids. PV systems include inverters to convert the DC power output by the PV system to AC power, which can then be supplied to the power grid. Such inverters have the potential to provide reactive power to the power grid. However, as the inverters of DERs are typically owned by utility customers rather than by the utility itself, there is no incentive for the customers to allow the utility to use the inverters for power grid voltage regulation.

While solutions exist for incentivizing provision of real power to the grid by DERs, these solutions are not easily transferred to the problem of reactive power management. Unlike real power production, reactive power production does not have a direct production cost. For example, when an inverter provides reactive power to the power grid, it may incur an opportunity cost, associated with lost revenue from curtailing real power production by an inverter. Further, during provision of reactive power, additional real power losses occur in the inverter circuit depending on the inverter's efficiency. It can also be difficult for a utility to determine an appropriate price to pay DERs to supply reactive power during a given time period. For example, consider a conservation voltage reduction use case in which a portion of a grid is operated at a voltage lower than the rated voltage to reduce power consumption of voltage-dependent loads. In this use case, the price a utility is willing to pay for injection of reactive power to lower the voltage at the portion of the grid should consider the overall energy savings that will be achieved by the conservation voltage reduction. Due to the complexity of determining an appropriate price for reactive power, large-scale deployment of DERs to dispatch reactive power to the power grid for voltage management is yet to be achieved.

### SUMMARY

Apparatus and methods are disclosed for double-auction transactive systems for harnessing inverters of DERs to dispatch reactive power to the power grid for voltage management purposes. A voltage management planning and assessment tool can be used to simulate voltage profiles that will be achieved along a feeder during a specified time period if one or more DERs are dispatched to source or sink varying amounts of reactive power to/from the feeder.

In some examples of the disclosed technology, a method includes producing a supply curve for a DER electrically coupled to a utility-operated power grid based at least in part on a present loading level of an inverter of the DER. The supply curve relates quantities of reactive power the DER will supply to the power grid during an upcoming interval to corresponding marginal prices the DER will charge to supply the reactive power. The method can further include transmitting a message indicating the supply curve, and responsive to the transmitting, receiving an indication of a quantity of reactive power for the DER to supply to the power grid during the upcoming interval. The indicated quantity can be based at least in part on the transmitted supply curve and a demand curve relating quantities of reactive power demanded by the utility to be supplied to the power grid during the upcoming interval to corresponding marginal prices the utility will pay for the reactive power. The method can further include producing an output to cause the DER to supply the indicated quantity of reactive power to the power grid during the upcoming interval. The DER can include, for example, a rooftop PV system electrically coupled to the inverter, and/or an electrical energy storage system electrically coupled to the inverter.

In some examples of the disclosed technology, the present loading level of the inverter reflects a quantity of real power being produced by the inverter relative to an apparent power capacity of the inverter. Further, in some examples of the disclosed technology, producing the supply curve includes producing a non-zero-curtailment curve corresponding to a portion of the apparent power capacity of the inverter being used for real power production, producing a zero-curtailment curve corresponding to a portion of the apparent power capacity of the inverter not being used for real power production, and combining the non-zero-curtailment and zero-curtailment curves to obtain a cost curve. The supply curve can describe the relationship between the quantity and marginal price of reactive power offered by the DER.

In some examples of the disclosed technology, the producing of the non-zero-curtailment curve is based at least in part on a cost of curtailment of real power production by the inverter. The cost of curtailment can be determined based at least in part on one or more of the following: an electricity tariff, a quantity of apparent power being produced by the inverter, a quantity of real power being produced by the inverter, or a quantity of reactive power being produced by the inverter.

In some examples of the disclosed technology, the producing of the zero-curtailment curve is based at least in part on a cost of real power loss due to production of reactive power at the inverter. The cost of real power loss due to production of reactive power at the inverter can be determined based at least in part on an electricity tariff and an efficiency curve for the inverter.

In some examples of the disclosed technology, the method can be performed by a controller for the DER which includes a network adapter, one or more processors configured to produce a signal to cause the inverter to source a desired quantity of reactive power to the power grid or sink a desired quantity of reactive power from the power grid, and one or more computer-readable storage media. The one or more computer-readable storage media can store computer-executable instructions that, when executed by the processors, cause the controller to perform the method.

In some examples of the disclosed technology, a method includes receiving, from each of one or more smart inverters electrically coupled to a feeder of a power grid, a message indicating a supply curve for reactive power for an upcoming interval. The method can further include producing an aggregate supply curve from the received supply curves, receiving, from a utility operating the power grid, a message indicating a demand curve for reactive power, and determining coordinates of an intersection point of the demand curve with the aggregate supply curve. The coordinates can indicate a clearing price for reactive power during the upcoming interval and a clearing quantity of reactive power to be supplied to the feeder by the one or more smart inverters during the upcoming interval. The method can further include determining, for at least one of the one or more smart inverters, a portion of the clearing quantity of reactive power to be supplied to the feeder by the smart inverter during the upcoming interval, and sending a signal to cause the one or more smart inverters to collectively supply the clearing quantity of reactive power to the feeder during the upcoming interval in exchange for payment by the utility at the clearing price. The method can be performed by a coordinator comprising a network adapter, one or more processors, and one or more computer-readable storage media storing computer-executable instructions.

In some examples of the disclosed technology, the supply curve for reactive power for at least one of the smart inverters includes a plurality of seller price-quantity pairs, each seller price-quantity pair indicating a quantity of reactive power and a minimum marginal price the smart inverter will accept to supply that quantity of reactive power during the upcoming interval. Producing the aggregate supply curve from the received supply curves can include sorting the seller price-quantity pairs from the received supply curves in ascending order of minimum marginal price. For at least one of the one or more smart inverters, the determination of the portion of the clearing quantity of reactive power to be supplied to the feeder by the smart inverter during the upcoming interval can be based at least in part on a contribution of the supply curve for the smart inverter to the aggregate supply curve at the intersection point.

In some examples of the disclosed technology, a method includes determining a voltage at a feeder of a power grid operated by a utility, and determining a plurality of buyer price-quantity pairs based at least in part on an extent to which the voltage at the feeder deviates from a reference value, each buyer price-quantity pair indicating a quantity of reactive power and a marginal price the utility will pay for that quantity of reactive power to be supplied to the feeder during an upcoming interval. For at least one of the buyer price-quantity pairs, the quantity of reactive power is either positive or negative. The method can further include producing a demand curve from the buyer price-quantity pairs, transmitting a message indicating the demand curve, and responsive to the transmitting, receiving an indication of a clearing price and a clearing quantity of reactive power for the upcoming interval. The clearing price and clearing quantity can be based at least in part on the transmitted demand curve and an aggregate supply curve relating quantities of reactive power that one or more smart inverters electrically coupled to the feeder will supply to the feeder during the upcoming interval to corresponding marginal prices the one or more smart inverters will charge to supply the quantities of reactive power during the upcoming interval. The method can further include transmitting a signal that causes the one or more smart inverters to collectively supply the clearing quantity of reactive power to the feeder during the upcoming interval.

In some examples of the disclosed technology, the marginal price the utility will pay for a given quantity of reactive power increases as the voltage at the feeder deviates further from a reference value. Further, for at least one of the buyer price-quantity pairs, the marginal price the utility will pay for the quantity of reactive power can be determined based at least in part on an estimated financial impact of the feeder not being supplied the quantity of reactive power during the upcoming interval. Additionally or alternatively, for at least one of the buyer price-quantity pairs, the marginal price the utility will pay for the quantity of reactive power can be determined based at least in part on an estimated cost for the feeder to receive the quantity of reactive power from a source other than the one or more smart inverters. The source other than the one or more inverters can be a capacitor bank electrically coupled to the feeder, for example.

In some examples of the disclosed technology, a method includes obtaining a computer model of a portion of a power grid, obtaining electricity price data, and obtaining capability data for one or more DERs electrically coupled to the portion of the power grid. The computer model of the portion of the power grid can include a load profile of a feeder electrically coupled to the one or more DERs. The electricity price data can include a tariff set by an electric power distribution utility operating the power grid, and/or a wholesale electricity price. The capability data for the one or more DERs can include respective capability curves for the one or more DERs.

The method can further include receiving input specifying a time and input specifying values of configuration parameters for the one or more DERs. The configuration parameters for a given DER can include whether to configure the DER as a reactive power source or sink, and a value indicating a portion of a reactive power capacity of the inverter to be used. The method can further include performing a market clearing simulation for the specified time based at least in part on the computer model, the electricity price data, the capability data, and the specified configuration parameter values, and producing market clearing simulation results including a clearing quantity of reactive power and a clearing price of reactive power. Responsive to the producing of the market clearing simulation results, the method can include configuring the one or more DERs to in accordance with the specified configuration parameter values and actuating the one or more DERs to dispatch the clearing quantity of reactive power to the portion of the power grid for a finite time period beginning at the specified time.

In some examples of the disclosed technology, performing the market clearing simulation includes producing a simulated reactive power supply curve for each DER, producing a simulated aggregate reactive power supply curve from the simulated reactive power supply curves, producing a simulated reactive power demand curve for the portion of the power grid, and determining an intersection point of the simulated aggregate reactive power supply curve and the simulated reactive power demand curve. The clearing quantity of reactive power and clearing price of reactive power can be determined based at least in part on the intersection point. The market clearing simulation can be performed in response to receiving a user request to display simulation results. The method can further include, responsive to receiving the user request, producing a graph of a hypothetical voltage profile along a feeder of the power grid at the specified time with the one or more DERs engaged to source or sink the clearing quantity of reactive power in accordance with the specified configuration parameters, and displaying the graph.

In some examples of the disclosed technology, the market clearing simulation is performed in response to receiving a user request to calculate a monetary cost and a monetary benefit associated with engaging the one or more DERs to source or sink the clearing quantity of reactive power in accordance with the specified configuration parameters. In these examples, the method can further include, responsive to receiving the user request, calculating the monetary cost and the monetary benefit based at least in part on the clearing quantity, the clearing price, and the electricity price data, and displaying the estimated monetary cost and monetary benefit.

In some examples of the disclosed technology, a system includes a power grid operated by a utility, an administrator controller, one or more DERs having respective controllers, and a coordinator controller. The administrator controller can be associated with the utility and configured to produce a demand curve relating quantities of reactive power demanded by the utility to be supplied to the power grid during an upcoming interval to corresponding marginal prices the utility will pay for the reactive power, and transmit a message indicating the demand curve. The one or more DERs can be electrically coupled to a feeder of the power grid and operable to source reactive power to the feeder or sink reactive power from the feeder, with the controller for at least one of the DERs being configured to produce a supply curve relating quantities of reactive power offered by the DER for the upcoming interval to corresponding marginal prices the DER will accept in exchange for supplying the reactive power to the power grid during the upcoming interval, and transmit a message indicating the supply curve. The coordinator controller can be configured to receive the message indicating the demand curve from the administrator controller and the messages indicating the supply curves from the respective controllers of the one or more DERs, determine a clearing price and clearing quantity for reactive power for the upcoming interval based at least in part on the demand curve and the supply curves, and send a signal that causes the one or more DERs to collectively dispatch the clearing quantity of reactive power to the feeder during the upcoming interval.

In some examples of the disclosed technology, the administrator controller is configured to produce the demand curve based at least in part on one or more of the following: an estimated financial impact of the feeder not being supplied the demanded quantity of reactive power during the upcoming interval, or an estimated cost for the feeder to receive the demanded quantity of reactive power from a source other than the one or more DERs. Further, the controller for at least one of the DERs can be configured to produce the supply curve for the DER based at least in part on a loading level of the DER.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the disclosed technology will become more apparent from the following detailed description, which proceeds with reference to the accompanying figures.

### BRIEF DESCRIPTION OF THE DRAWINGS

FIG. 1 illustrates an example environment in which certain apparatus and methods, including a plurality of DERs comprising inverters, can be implemented according to the disclosed technology.

FIG. 2 is a diagram illustrating an example computing environment in which certain examples of the disclosed technology can be implemented.

FIG. 3 is a diagram illustrating inputs and outputs of a transactive mechanism in accordance with certain examples of the disclosed technology.

FIG. 4A illustrates an example of market clearing for reactive power according to certain examples of the disclosed technology.

FIG. 4B illustrates an exemplary loading profile and reactive power supply curve for a fully loaded inverter.

FIG. 4C illustrates an exemplary loading profile and reactive power supply curve for an unloaded inverter.

FIG. 4D illustrates an exemplary loading profile and reactive power supply curve for a partially loaded inverter.

FIG. 5 illustrates exemplary reactive power demand curves, in accordance with certain examples of the disclosed technology.

FIG. 6 illustrates a circuit diagram of an exemplary portion of a distribution system used in a proof-of-concept study for the disclosed technology.

FIGS. 7A-7D illustrate results of an exemplary market clearing simulation, in accordance with certain examples of the disclosed technology.

FIG. 8A illustrates a plot of a CVR demand curve, a supply curve for a partially loaded inverter, and a supply curve for a fully loaded inverter, in accordance with certain examples of the disclosed technology.

FIG. 8B illustrates a detail view of a portion of FIG. 8A.

FIG. 9 illustrates, in the form of bar graphs, individual reactive power supply curves and an aggregate reactive power supply curve produced from the individual reactive power supply curves, in accordance with certain examples of the disclosed technology.

FIG. 10 illustrates a CVR benefit curve and a marginal CVR benefit curve, in accordance with certain examples of the disclosed technology.

FIG. 11 illustrates the results of a market clearing simulation, in accordance with certain examples of the disclosed technology.

FIGS. 12-13 illustrate screenshots of graphical user interfaces of a voltage management planning and assessment tool, in accordance with certain examples of the disclosed technology.

FIG. 14 illustrates an example method of determining a clearing quantity of reactive power to be supplied to a power grid by a DER, as can be performed in some examples of the disclosed technology.

FIG. 15 illustrates an example method of producing a supply curve for reactive power, as can be performed in some examples of the disclosed technology.

FIG. 16 illustrates an example method of producing a non-zero-curtailment curve for an inverter, as can be performed in some examples of the disclosed technology.

FIG. 17 illustrates an example method of producing a zero-curtailment curve for an inverter, as can be performed in some examples of the disclosed technology.

FIG. 18 illustrates an example method of controlling a plurality of DERs to supply a clearing quantity of reactive power to a power grid, as can be performed in some examples of the disclosed technology.

FIG. 19 illustrates an example method of producing a demand curve for reactive power and controlling a plurality of DERs to supply a clearing quantity of reactive power determined based on the demand curve to a power grid, as can be performed in some examples of the disclosed technology.

FIGS. 20-21 illustrate example methods of performing a market clearing simulation for reactive power using a voltage management planning and assessment tool, in accordance with certain examples of the disclosed technology.

### DETAILED DESCRIPTION

I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “evaluate,” “determine,” “send,” “transmit,” and “perform” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions stored on one or more computer-readable media (e.g., non-transitory computer-readable storage media, such as one or more optical media discs, volatile memory components (such as DRAM or SRAM), or nonvolatile memory components (such as hard drives and solid state drives (SSDs))) and executed on a computer (e.g., any commercially available computer, including smart phones or other mobile devices that include computing hardware). Any of the computer-executable instructions for implementing the disclosed techniques, as well as any data created and used during implementation of the disclosed embodiments, can be stored on one or more computer-readable media (e.g., non-transitory computer-readable storage media). The computer-executable instructions can be part of, for example, a dedicated software application, or a software application that is accessed or downloaded via a web browser or other software application (such as a remote computing application). Such software can be executed, for example, on a single local computer (e.g., as a process executing on any suitable commercially available computer) or in a network environment (e.g., via the Internet, a wide-area network, a local-area network, a client-server network (such as a cloud computing network), or other such network) using one or more network computers. For example, as described herein, a voltage management planning and assessment tool can be implemented by a software application.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C, C++, Java, or any other suitable programming language. Likewise, the disclosed technology is not limited to any particular computer or type of hardware. Certain details of suitable computers and hardware are well-known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods can also be implemented by specialized computing hardware that is configured to perform any of the disclosed methods. For example, the disclosed methods can be implemented by an integrated circuit (e.g., an application specific integrated circuit (“ASIC”) or programmable logic device (“PLD”), such as a field programmable gate array (“FPGA”)). The integrated circuit or specialized computing hardware can be embedded in or directly coupled to an electrical device (or element) that is configured to interact with controllers and coordinators. For example, the integrated circuit can be embedded in or otherwise coupled to an inverter, as a controller of the inverter, in which case the inverter may be referred to as a “smart inverter.”

II. Introduction to the Disclosed Technology

Methods and apparatus are disclosed for implementing transactive control frameworks to incentivize DERs to source reactive power to/sink reactive power from a power grid to achieve a desired voltage profile.

Examples of DERs according to the disclosed technology include customer or third-party-owned PV systems and battery storage systems.

III. Example Power Distribution Network

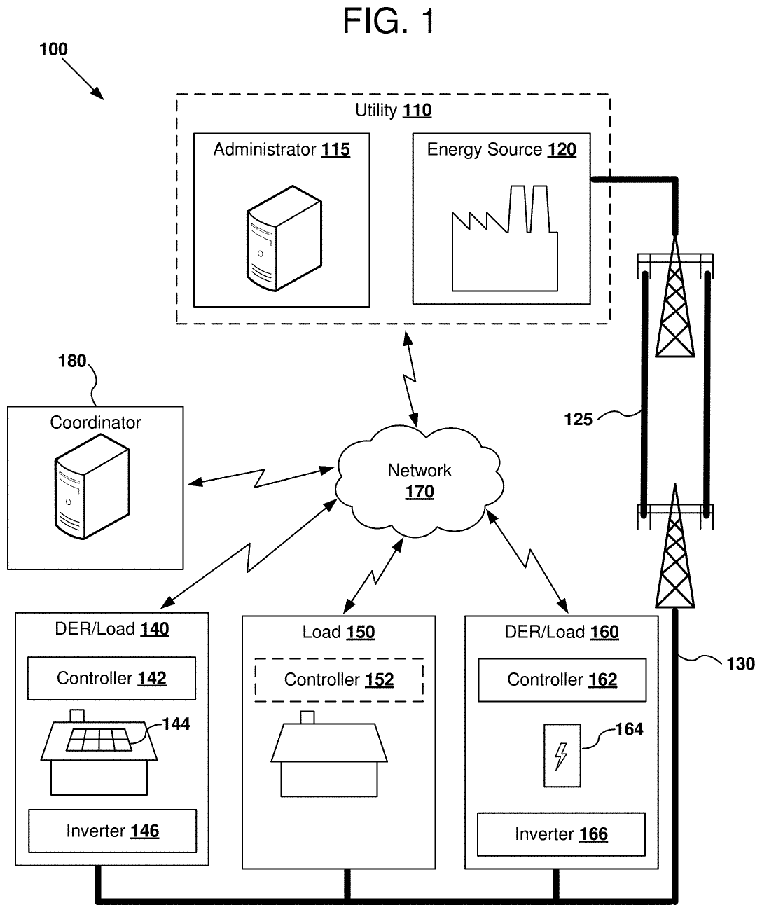

A diagram 100 illustrating an example of a possible power distribution network (“power grid”) topology for an environment in which DERs are utilized for voltage profile management according to the disclosed technology is depicted in FIG. 1. As shown, a utility 110 includes an energy source 120 coupled to a power grid. While a single energy source 120 is shown, the utility may include a plurality of energy sources coupled to the power grid. Non-limiting examples of energy source 120 include a base load power plant 111 (e.g., a coal, nuclear, or hydroelectric power plant), a peak load power plant (e.g., a gas or diesel turbine electric generator), a load balancing power plant (e.g., a pumped water storage or battery energy storage plant), and an intermittent load power plant (e.g., including PV and other solar-based electric generators, wind turbines, and tidal energy sources).

Utility 110 further includes administrator 115. Administrator 115 is operable to submit data to and receive data from other components via a network 170, as well as to perform operations on and otherwise process data. In one example, administrator 115 is implemented using a microcontroller, memory, and suitable input/output resources. In other examples, administrator 115 can be implemented using programmable logic. As discussed further below, administrator 115 can produce a demand curve reflecting the utility's willingness to pay DERs in exchange for the DERs providing reactive power support to the power grid (e.g., sourcing or sinking a desired amount of reactive power).

Diagram 100 further illustrates a coordinator 180. Coordinator 180 is operable to submit data to and receive data from other components via network 170, as well as to perform operations on and otherwise process data. In one example, coordinator 180 is implemented using a microcontroller, memory, and suitable input/output resources. In other examples, coordinator 180 can be implemented using programmable logic. As discussed further below, coordinator 180 can receive a demand curve from the utility, as well as supply curves from one or more DERs. Coordinator 180 can generate an aggregate supply curve from the received supply curves, and determine an intersection point of the aggregate supply curve with the demand curve received from the administrator of the utility.

The power grid includes one or more transmission lines 125 that carry power from the energy source 120 to energy consumers (loads) as well as DERs via one or more feeders electrically coupled thereto. In the depicted example, a single feeder 130 is electrically coupled to DERs 140 and 160, which are also loads, and load 150. However, in other examples, a plurality of feeders may be electrically coupled to the transmission lines, each feeder electrically coupled to one or more DERs and/or one or more residential, industrial, and commercial energy consumers.

In the depicted example, DER 140 includes a PV array 144 electrically coupled to feeder 130 via an inverter 146. DER 140 can supply energy generated by PV array 144 to the power grid. DER 140 can also consume energy received from the power grid (hence its designation as a “load”). Inverter 146 can convert DC power generated by PV array 144 to AC power, so that it can be supplied to the power grid.

In contrast, load 150 is not a DER in the example shown in FIG. 1. Load 150 can consume energy received from the power grid, but it is not configured to supply energy to the power grid. For example, load 150 may be a residential, commercial, or industrial property that does not generate real or reactive power for supply to the power grid.

In the depicted example, DER 160 includes a battery storage system 164 electrically coupled to feeder 130 via an inverter 166. Inverter 166 can convert DC power stored in battery storage system 164 to AC power so that it can be supplied to the power grid. Battery storage system 164 is an example of an electrical energy storage system (ESS).

In other examples, other types, numbers, and combinations of DERs configured to source or sink reactive power may be coupled to the feeder.

DERs 140 and 160 include controllers 142 and 162, respectively. Further, load 150 optionally includes controller 152. Controllers 142, 152, and 162 are each operable to submit data to and receive data from other components via a computer network 170. In some examples, one or more of the controllers are implemented using a microcontroller, memory, and suitable input/output resources for receiving signals carrying sensor data local to the DER and controlling the DER (e.g., by actuating switches/relays and other components of the DER). In other examples, the controllers can be implemented using programmable logic or a general-purpose computer configured to receiving signals carrying signal data and generate signals for controlling the DER.

The controller of a given DER can be located at the DER, e.g., at a residence, industrial building, or commercial building that includes a PV plant and/or ESS and an inverter. The controller can be operably coupled to an inverter of the DER, and optionally to a PV plant and/or ESS of the DER, via a wired or wireless connection. In other examples, however, the controller of the DER can be located remotely, and can control operation of the DER and the components thereof (e.g., the inverter of the DER) by sending signals via a network, such as network 170.

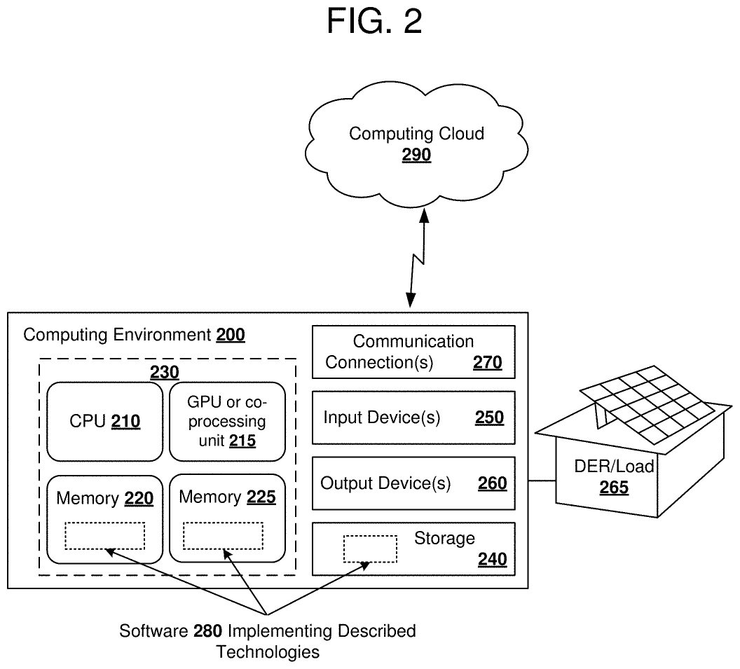

Each of the controllers, the coordinator 180, and the administrator 115 can have computer architecture(s) similar to those illustrated in FIG. 2 and further discussed below. The computing devices associated with the controllers, coordinator, and administrator are not limited to traditional personal computer and server architectures, but rather can comprise other computing hardware configured to connect to and communicate with the network 170 (e.g., specialized computing hardware comprising one or more integrated circuits such as ASIC or programmable logic devices configured to perform any of the disclosed methods).

As shown in FIG. 1, each DER can send and receive data via the network to the coordinator 180. The coordinator 180 receives offer data from the DERs, including supply curves, and transmits dispatch instructions back to the DERs. The coordinator 180 also receives bid data from administrator 115, including demand curves. Before each market clearing cycle, administrator 115 can submit bid data to coordinator 180 reflecting the utility's willingness to pay for reactive power. The bid data can include a plurality of price-quantity (P-Q) pairs or a demand curve generated based on a plurality of P-Q pairs. Further, before each market clearing cycle, the controllers of the DERs can submit offer data to coordinator 180, reflecting the DER's willingness to supply reactive power. The offer data submitted by each DER can include a plurality of P-Q pairs or a supply curve generated based on a plurality of P-Q pairs. The coordinator can then generate an aggregate supply curve from the P-Q pairs and/or supply curves received from the DERs.

In some examples, each of the DERs submits a single bid to the coordinator 180 for each finite time period. In other examples, additional bids are submitted in an iterative process. The coordinator 180 in turn aggregates offers from a number of DERs participating in the market for the finite time period, generates an aggregate supply curve based on the aggregated offers, and calculates an intersection point of the aggregate supply curve with a demand curve received from administrator 115. A clearing P-Q pair associated with the intersection point is then determined. Depending on the clearing price and quantity, instructions to source or sink a specified amount of reactive power can then be transmitted from the coordinator 180 to each of the DERs. The controllers of the DERs respond to the instructions by, for example, actuating their inverters to source or sink the specified amount of reactive power to/from the power grid.

As will be more fully explained below, this process can be repeated at fixed intervals (e.g., intervals of one hour or less, intervals of ten minutes or less, or intervals of five minutes or less).

Network 170 can be implemented as a local area network (“LAN”) using wired networking (e.g., using IEEE standard 802.3 or other appropriate wired networking standard), fiber optic cable, cable modem (e.g., using the DOCSIS standard), and/or wireless networking (e.g., IEEE standards 802.11a, 802.11b, 802.11g, or 802.11n, WiMax (e.g., IEEE standard 802.16), a metropolitan area network (“MAN”), satellite networking, microwave, laser, or other suitable wireless networking technologies). In certain examples, at least part of the network 170 includes portions of the internet or a similar public network. In certain examples, at least part of the network 170 can be implemented using a wide area network (“WAN”), a virtual private network (“VPN”), or other similar public and private computer communication networks.

The various possible roles and functionalities of the DERs, coordinator 180, and administrator 115 will be described in more detail in the following sections.

IV. Example Computing Environment

FIG. 2 illustrates a generalized example of a suitable computing environment 200 in which described embodiments, techniques, and technologies can be implemented. For example, the computing environment 200 can implement any of the DER controllers, the coordinator, and/or the administrator, as described herein. For illustrative purposes, computing environment 200 is shown coupled to a DER 265, which may correspond to DER 140 or 160 of FIG. 1, for example.

The computing environment 200 is not intended to suggest any limitation as to scope of use or functionality of the technology, as the technology may be implemented in diverse general-purpose or special-purpose computing environments. For example, the disclosed technology may be implemented with other computer system configurations, including hand held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 2, the computing environment 200 includes at least one central processing unit 210 and memory 220. In FIG. 2, this most basic configuration 230 is included within a dashed line. The central processing unit 210 executes computer-executable instructions and may be a real or a virtual processor. In a multi-processing system, multiple processing units execute computer-executable instructions to increase processing power and as such, multiple processors can be running simultaneously. The memory 220 may be volatile memory (e.g., registers, cache, RAM), non-volatile memory (e.g., ROM, EEPROM, flash memory, etc.), or some combination of the two. The memory 220 stores software 280, images, and video that can, for example, implement the technologies described herein. A computing environment may have additional features. For example, the computing environment 200 includes storage 240, one or more input devices 250, one or more output devices 260, and one or more communication connections 270. An interconnection mechanism (not shown) such as a bus, a controller, or a network, interconnects the components of the computing environment 200. Typically, operating system software (not shown) provides an operating environment for other software executing in the computing environment 200, and coordinates activities of the components of the computing environment 200.

The storage 240 may be removable or non-removable, and includes magnetic disks, magnetic tapes or cassettes, CD-ROMs, CD-RWs, DVDs, or any other medium which can be used to store information and that can be accessed within the computing environment 200. The storage 240 stores instructions for the software 280, plugin data, and messages, which can be used to implement technologies described herein.

The input device(s) 250 may be a touch input device, such as a keyboard, keypad, mouse, touch screen display, pen, or trackball, a voice input device, a scanning device, or another device, that provides input to the computing environment 200. For audio, the input device(s) 250 may be a sound card or similar device that accepts audio input in analog or digital form, or a CD-ROM reader that provides audio samples to the computing environment 200. The output device(s) 260 may be a display, printer, speaker, CD-writer, or another device that provides output from the computing environment 200. The output device(s) 260 can also include interface circuitry for sending actuating commands. For example, when computing environment 200 implements a DER controller, the output device(s) can include interface circuitry for sending commands to activate or deactivate actuators (e.g., switches/relays, electric actuators such as solenoids, pneumatic actuators, etc.) of the DER (e.g., actuators of an inverter of the DER) which cause the DER to source or sink a desired amount of reactive power, or to request sensor or other data from the DER.

The communication connection(s) 270 enable communication over a communication medium (e.g., a connecting network) to another computing entity. The communication medium conveys information such as computer-executable instructions, compressed graphics information, video, or other data in a modulated data signal. The communication connection(s) 270 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed controllers and coordinators. Both wired and wireless connections can be implemented using a network adapter. In a virtual host environment, the communication(s) connections can be a virtualized network connection provided by the virtual host. In some examples, the communication connection(s) 270 are used to supplement, or in lieu of, the input device(s) 250 and/or output device(s) 260 in order to communicate with the DERs and/or sensors.

Some embodiments of the disclosed methods can be performed using computer-executable instructions implementing all or a portion of the disclosed technology in a computing cloud 290. For example, data acquisition and DER actuation can be performed in the computing environment while computing energy response functions or bid generation can be performed on servers located in the computing cloud 290.

Computer-readable media are any available media that can be accessed within a computing environment 200. By way of example, and not limitation, with the computing environment 200, computer-readable media include memory 220 and/or storage 240. As should be readily understood, the term computer-readable storage media includes the media for data storage such as memory 220 and storage 240, and not transmission media such as modulated data signals.

V. System Overview

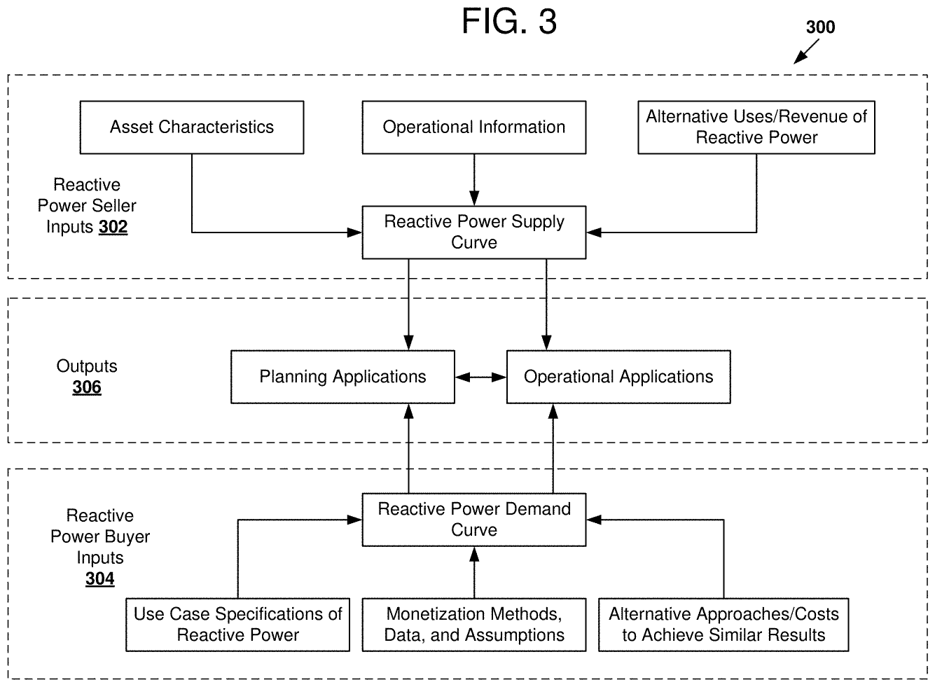

FIG. 3 is a diagram illustrating inputs and outputs of a transactive mechanism in accordance with certain examples of the disclosed technology.

Transactive mechanism 300 includes a plurality of reactive power seller inputs 302. These can include asset characteristics (e.g., characteristics of inverter assets at DERs), operational information (e.g., a current loading level of an inverter of a DER), and alternative uses for reactive power generated by the reactive power sellers and any associated revenue. The reactive power seller inputs can further include a reactive power supply curve produced based on the other inputs.

The transactive mechanism further includes a plurality of reactive power buyer inputs 304. The reactive power buyer inputs can include use case specifications for reactive power; reactive power monetization methods, data, and assumptions; and alternative approaches/costs to achieve similar results (e.g., voltage management approaches other than purchasing reactive power from DERs). The reactive power buyer inputs can further include a reactive power demand curve produced based on the other inputs.

Reactive power seller inputs 302 and reactive power buyer inputs 304 can be input to a transactive mechanism 300, which in turn can generate outputs 306. In the depicted example, outputs 306 include planning applications and operational applications.

VI. Overview of Transactive Systems

Transactive energy systems are a class of systems in which economics and controls converge to address problems requiring control or coordination of a variety of assets in an electric power system. The GridWise® Architecture Council (GWAC 2018) formally defines a transactive energy system as a system of economic and control mechanisms that allows the dynamic balance of supply and demand across the entire electrical infrastructure using value as a key operational parameter.

Practically speaking, one can consider transactive energy systems as a means of engaging flexibility to offset variability. They are particularly useful in considering how to monetize the value propositions associated with DER integration. The challenge is to identify the specific basis for each value stream, the relationships between value streams, and the spatial and temporal dimensions of the problem. These considerations lead to both the basis for monetization—for example, avoided cost—and the identification of a specific transactive mechanism suited to the specific control and coordination problem being addressed. The inventors herein have recognized that a double-auction market is a transactive mechanism well suited to the problem of creating incentive signals to engage smart inverters.

VII. Double Auction Based Transactive Systems

A double auction refers to a market clearing process in which exchanging entities (e.g., the buyers and sellers) simultaneously submit their bids to exchange a commodity. The bids and offers typically constitute price-quantity pairs, specifying the amount of a commodity to be exchanged at a desired price. In some examples, the desired price need not be expressed in units of currency, but can be expressed in other units mutually-agreeable to the exchanging entities, and including the exchange of tangible commodities (e.g., stored energy, future deliveries of energy, credits, stored power, etc.). In some examples, the bids and offers may consist of a single price-quantity pair, or multiple such pairs, which form the supply and demand curves. Buyers' price-quantity pairs contain information on their willingness to pay (WTP), which is the maximum amount of money they are willing to pay for the corresponding amount of commodity. Hence, the price-quantity pair, and by extension the demand curve, contain information on buyers' preferences to consume the commodity. A buyer's demand curve is also referred to as the marginal benefit curve, because WTP for an incremental unit of a commodity represents the additional utility (and hence, marginal benefit) from consuming it. Similarly, sellers' price-quantity pairs contain information on their willingness to accept (WTA), which is the minimum amount of money they are willing to accept for the corresponding amount of the commodity. Hence, the price-quantity pairs contain information on sellers' implied costs to produce the commodity. It is reasonable to assume that most sellers operate with a profit motive, and hence, their WTA for a given amount of commodity must be greater than the production cost. In case of a purely competitive marketplace, and auction designs such as uniform price auctions, the sellers have no incentive to report anything but their true marginal production costs, and hence, the supply curve is the same as the marginal cost curve.

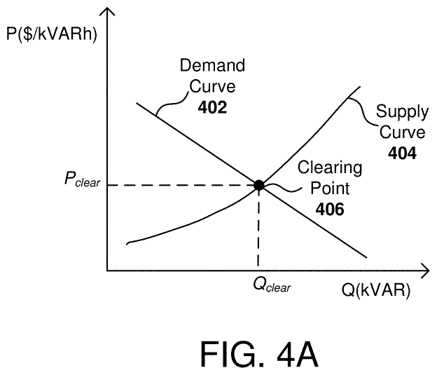

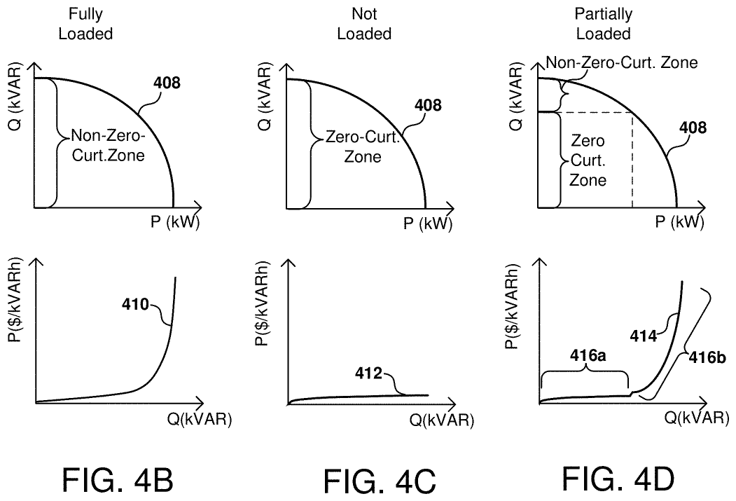

At the market clearing point, the buyers' WTP equals the sellers' WTA. The market clearing transaction occurs at the intersection of the demand and supply curves, revealing the market clearing price and the amount of commodity to be transacted. At the market clearing point, the buyers' WTP equals the sellers' WTA. An exemplary market clearing transaction is shown in FIG. 4A, in which a demand curve 402 intersects with a supply curve 404 at a clearing point 406. Clearing point 406 can also be represented as a P-Q pair, in which the price is the clearing price P_{clear} for reactive power and the quantity of reactive power to be transacted is the clearing quantity Q_{clear}.

Double-auction transactive energy systems have been used in both distribution and bulk-power systems to engage resources to help achieve various operational requirements of the power system. The specification of a transactive system begins with the identification of a desired operational objective (use case) to be achieved, such as management of voltage within the American National Standards Institute (ANSI) bounds on a distribution feeder. Once a use case has been identified, the next step involves specification of the commodity to be transacted along with its units of measurement and transaction, as well as identification of the counterparties-buyers and sellers. For instance, a distribution utility could transact with customer or third-party owned assets, such as inverters, to source or sink reactive power to manage the voltage on a distribution feeder. In this case, the commodity to be transacted is reactive power, and the buyer is a distribution utility. The next step involves translation of the desired operational objective into a transactive incentive signal, which is expressed using the same financial units as the seller's reported offer. In the context of a double-auction market, a transactive incentive signal represents the maximum price a distribution utility is willing to pay for the commodity, e.g., its demand or marginal benefit curve. The seller's cost for providing the commodity could be either the direct cost associated with production, or a cost based on implied or assumed trade-offs with other monetizable commodities. For instance, customers' WTA for providing flexibility with air-conditioning load (to manage line thermal constraints) can be derived from their temperature elasticities, e.g., the level of comfort they are willing to forego in return for a monetary compensation.

VIII. Transactive Mechanism to Engage Inverters for Reactive Power Support

A double-auction based transactive mechanism was designed and developed to engage inverters to provide reactive power support. The use case initially identified for proof-of-concept of the transactive mechanism was conservation voltage reduction (CVR), which is essentially a form of Volt-Var control (VVC) scheme exercised by distribution utilities to maintain voltage across the network, preferably within the lower half of the allowable ANSI range (±5%, or 114-120 V on a 120 V scale). This allows reduction in power and energy consumption of voltage dependent loads.

CVR is typically implemented as an area-wide scheme consisting of multiple feeders (or, a single feeder at the minimum) and engages the feeders' voltage control resources, including tap changing transformers, voltage regulators, capacitor banks, and sometimes more sophisticated power electronic devices (e.g., a D-STATCOM). Smart inverters may also be brought into the pool of CVR resources. These resources are directed by distribution automation systems or dedicated VVC systems at the substation for controlling reactive power as required to create space and time-varying voltage profiles necessary for CVR.

For the CVR use case, the monetized benefits of reduced energy consumption and procurement in the wholesale market were identified as the initial value drivers from the utility's perspective (buyer of reactive power). Hence, the time-varying demand curve was constructed to represent the utility's WTP for reactive power based on knowledge of energy savings, and the monetary value achieved thereby. The sources of reactive power included customer- and utility-owned inverters, attached to rooftop PV and battery systems. In providing reactive power, the resources incur opportunity cost, associated with lost revenue from real power, as well as power losses. Given that reactive power does not have a direct production cost, a supply curve from resources' perspective was constructed using the costs associated with lost opportunity of producing real power and the power losses due to inverter inefficiencies. The trade-off between real and reactive power was modeled using an inverter's P-Q capability curve.

IX. Supply Curve for Reactive Power

A supply curve in a transactive system describes the relationship between the quantity and the marginal price of a commodity being offered by a supplier. In this case, the commodity being transacted is reactive power and the supply curve needs to provide the marginal price of reactive power against the amount of reactive power offered by an asset (e.g., inverter). The cost of reactive power can be determined considering two aspects of inverter operation: one is the portion of inverter apparent capacity (kVA) used for real power production, and the other is the amount of additional power loss incurred for producing reactive power. A supply curve, also referred to as a marginal price curve, is obtained by taking the first derivative of the reactive power cost curve.

For example, FIG. 4B depicts an apparent power capacity curve 408 (top graph) and supply curve 410 (bottom graph) for a fully loaded inverter. Apparent power capacity curve 408 can alternatively be referred to as a capability curve of the inverter. In the example shown in FIG. 4B, the inverter is fully loaded to its rated apparent power capacity to convert real power from a solar PV array or an ESS; as shown, the apparent power output of the inverter is purely real power. As the inverter does not have any capacity left for sinking/sourcing reactive power, the inverter will need to curtail real power production if reactive power needs to be produced; as shown in the top graph 408, a non-zero-curtailment zone includes any non-zero amount of reactive power output by the inverter. Curtailment of the real power has two possible effects: (1) if the PV production is higher than the customer's own demand, it reduces the economic benefit to the inverter owner obtained from net energy delivered to the grid; or (2) if the PV production is less than or equal to the customer's own demand, it incurs additional energy cost. Therefore, depending on the case, the reduction in economic benefit from net energy metering or additional energy charges to meet the customer's own demand could be considered as the cost of reactive power for a fully loaded inverter.

In contrast, FIG. 4C depicts an apparent power capacity curve 408 (top graph) and supply curve 412 (bottom graph) for an inverter that is not loaded. As the inverter is not producing any real power, the apparent power output is zero, and the entire apparent power capacity is available for reactive power production. In this case, there is no equivalent loss of real power production due to curtailment; therefore, the cost of curtailment is zero, and the depicted zero-curtailment zone includes any non-zero amount of reactive power output by the inverter. However, due to the current flow through the inverter circuit, real power loss is incurred, which can be monetized using the price of electricity set by the utility (e.g., a time-of-use tariff). The cost of real power loss is used to construct the reactive power cost of the unloaded inverter. Inverter wear and tear, increased life cycle costs, etc., can also be considered for this case, if they are properly monetized.

When the inverter is partially loaded to produce real power, the supply curve will contain two portions, as shown in the bottom graph of FIG. 4D. A first portion 416a of a supply curve 414 corresponds to the unused apparent power capacity, where the curtailment cost is zero, and the cost of reactive power is determined using the real power loss in the circuit. A second portion 416b of supply curve 414 corresponds to the loaded part of the apparent capacity for real power production, where the cost of curtailment is nonzero. The real power curtailment cost is used as the reactive power cost for this portion of the reactive power supply curve.

An expression for the non-zero-curtailment portion of the reactive power cost is given in Equation (1), and the corresponding marginal cost (MC_{curt}) is obtained using Equation (2).

$$\begin{matrix}{C}_{curt} = ET \times [ ( \sqrt{{S}_{INV}^{2} - {Q}_{INV}^{2}} - {P}_{INV} ) - ( \sqrt{{S}_{INV}^{2} - {( {Q}_{INV} + {Q}_{OFR} )}^{2}} - {P}_{INV} ) ] & ( 1 ) \\ {MC}_{curt} = \frac{{dC}_{curt}}{{dQ}_{OFR}} & ( 2 )\end{matrix}$$

where C_{curt} is the reactive power cost calculated as the cost of curtailed real power; ET is the electricity tariff (Net Energy Metering tariff, utility specified rate, etc.); S_{INV}, P_{INV}, and Q_{INV} are rated apparent power, real power, and reactive power (if any, not including the reactive power for transactive process), respectively, at a given instant; and, Q_{OFR} is the reactive power offered by the inverter asset. Although P_{INV} in the first and second terms of the right-hand side of Equation (1) cancel out each other, these are kept to show the general form of the equation.

To assign cost to the zero-curtailment portion of the supply curve, additional real power loss for reactive power production is determined using the inverter efficiency curve provided by the manufacturer. The expression in Equation (3) describes the relationship between reactive power and real power loss on the inverter circuit, which is then used for the corresponding marginal cost, MCₗₒₛₛ, by applying Equation (4).

$$\begin{matrix}{C}_{loss} = ET \times \{ ( \frac{{s}_{2}}{{η}_{{INV}_{2}}} - {S}_{2} ) - ( \frac{{s}_{1}}{{η}_{{INV}_{1}}} - {S}_{1} ) \} & ( 3 ) \\ {MC}_{loss} = \frac{{dC}_{loss}}{{dQ}_{OFR}} & ( 4 )\end{matrix}$$

where Cₗₒₛₛ is the reactive power cost calculated as the cost of real power loss to produce reactive power; ET is the electricity tariff; S₁ and S₂ are inverter outputs without and with reactive power supplied, respectively, for the transactive process; and η_{INV1} and η_{INV2} are the inverter efficiencies at the apparent power output S₁ and S₂, respectively, which can be determined from a manufacturer-supplied curve or a test report.

While the example above discusses only real power loss in the construction of the zero-curtailment portion of the supply curve, inverter wear and tear, lifetime, etc. can also be considered if they are monetizable. Technically, the non-zero-curtailment portion of the supply curve should also include a real power loss component, but it is much lower than the curtailment cost.

X. Demand Curve for Reactive Power

A demand curve in a transactive system describes the relationship between the quantity and marginal price of a commodity being demanded by an entity. With the commodity being reactive power, the demand curve provides the marginal price of reactive power that the buyer (e.g., the utility) is willing to pay for a given amount of reactive power. Marginal price from the buyer's perspective can be estimated based on the benefit to the buyer of generating/consuming reactive power. Monetization of reactive power benefit is a rather complex task that requires comprehensive understanding of the financial impact of not receiving reactive power, the cost of alternative approaches to acquire reactive power, etc. Instead of considering a specific use case (e.g., CVR), a conceptual demand curve can be constructed as a function of feeder voltage deviation from an arbitrary reference value (e.g., 1.0 V). Thus, how changes in the demand curve as a result of voltage deviation in the feeder drive the market interaction in a transactive process can be analyzed. Voltage deviation can be incorporated in the construction of the demand curve in such a manner that it simulates a tendency to pay a higher price if the voltage deviation increases, with the goal of achieving a target voltage.

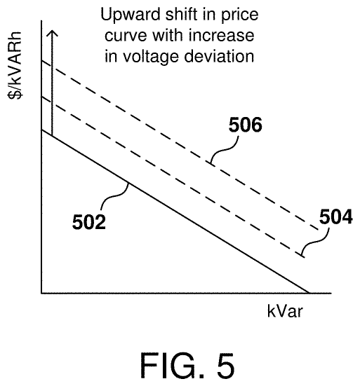

FIG. 5 shows sample demand curves 502, 504, and 506 for increasing voltage deviation from a reference value. Demand curve 502 represents the reference value, demand curve 504 represents a first amount of voltage deviation from the reference value, and demand curve 506 represents a second amount of voltage deviation from the reference value, with the second amount being larger than the first amount. The illustrated demand curves demonstrate the willingness of a reactive power buyer to pay higher prices as the voltage deviation increases.

Accordingly, in some examples, a plurality of buyer P-Q pairs can be determined based at least in part on an extent to which the voltage at the feeder deviates from a reference value, each buyer price-quantity pair indicating a quantity of reactive power and a marginal price the utility will pay for that quantity of reactive power to be supplied to the feeder during an upcoming interval. As shown in FIG. 5, the marginal price the utility will pay for a given quantity of reactive power may increase as the voltage at the feeder deviates further from a reference value.

XI. Market Clearing Simulation

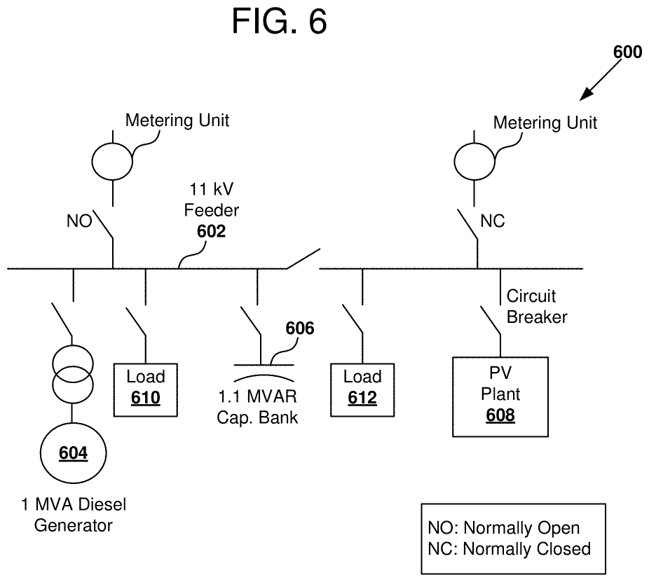

FIG. 6 illustrates a circuit diagram 600 of an exemplary distribution system used in a proof-of-concept study for the disclosed technology.

The aim of the proof-of-concept study was to develop an understanding of the applicability of transactive approach for acquiring reactive power from customer-owned assets, and to design and validate methods for developing the basic elements of transactive system (e.g., supply curve, demand curve, and market simulation mechanism). The distribution system used in the proof-of-concept study is a model of a distribution feeder 602 that connects a facility's substation and the local electric utility's zone substation supplying the facility. Feeder 602 is an approximately 8 km long, 11 kV line with a step voltage regulator (SVR) in the middle, which was deactivated for our simulation since the main study feeder under consideration does not have an SVR. The facility has a 3 MW PV plant 608 and a 0.6 MW/0.76 MWh lithium-ion ESS. However, for the simulation, only the PV inverters are used for reactive power capacity (3.5 MVA). As shown, circuit diagram 600 further includes a 1 MVA diesel generator 604, a 1.1 MVAR capacitor bank 606, a PV plant 608, loads 610 and 612, metering units, and circuit breakers.

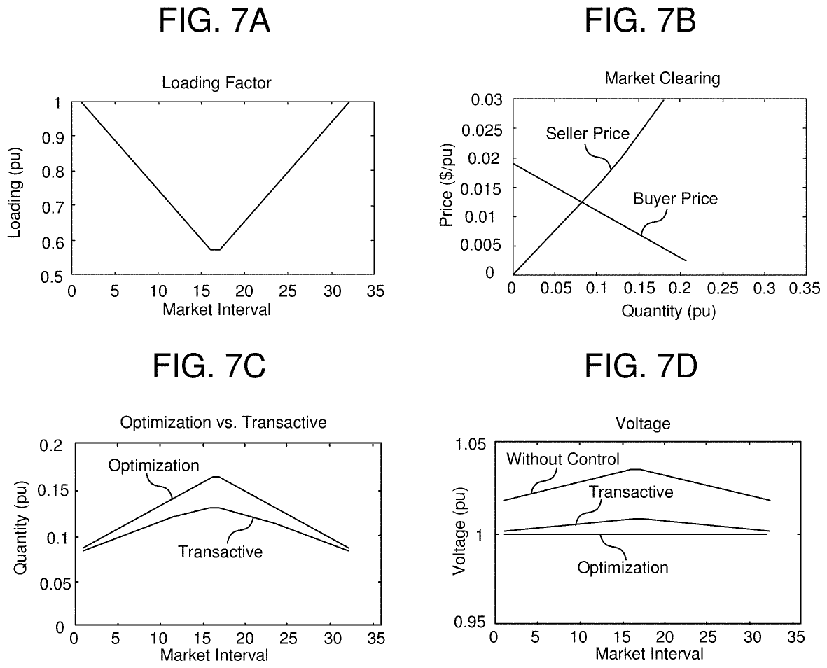

FIGS. 7A-D illustrate results of an exemplary market clearing simulation for the distribution system shown in circuit diagram 600.

In certain examples of the double-auction market clearing process described herein, a seller will submit their reactive power supply curve and a buyer will submit their reactive power demand curve. Market clearing is achieved if the supply and demand curves intersect. Since voltage-rise during a lightly loaded condition is a major technical challenge faced by power distribution utilities, a proof-of-concept study was set up to vary the loading of feeder 602 according to the pattern shown in FIG. 7A, to create a gradual increase in voltage. As the voltage at feeder 602 increases, so does its deviation from the reference value of 1.0. Distribution network voltage unbalance is not considered in this work and the reported voltage values represent equivalent positive-sequence voltage magnitudes only. Intersection points of the supply and demand curves constructed using the approach described in Sections IX-X above were tracked to obtain market clearing. The x-axis intercept of the market clearing point is the amount of reactive power that is dispatched by the inverter at the cleared price, which is the y-axis intercept of the clearing point, as shown in FIG. 7B. Following this approach, reactive power dispatch for all the points in the loading factor profile is obtained, and the amount of reactive power procured using the transactive approach is shown in FIG. 7C, with the resulting voltage profile shown in FIG. 7D.

For comparison purposes, optimal power flow analysis of the circuit is conducted to determine the reactive power required to achieve the reference voltage (1.0), which is overlaid in FIG. 7C with the reactive power obtained using the transactive process. The significance of the amount of reactive power obtained using the transactive approach is that it is “the amount” for which the marginal economic benefit is equal to the marginal cost, even if it is not the same as the amount obtained using optimal power flow. While the particular case presented here shows that the amount of reactive power determined using the transactive approach is lower than the amount of reactive power obtained by running optimal power flow, varying the demand curve parameters to increase sensitivity of price with voltage deviation could produce different results.

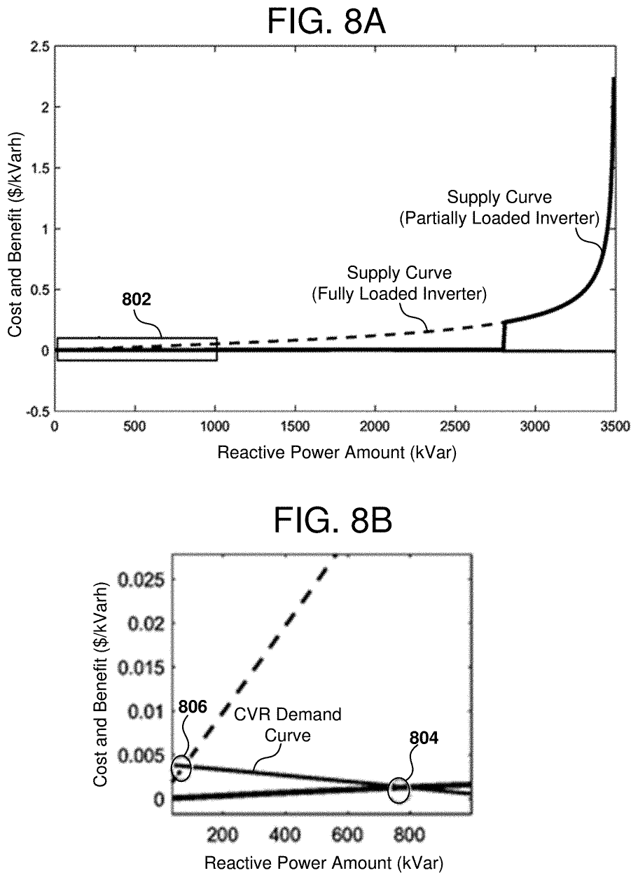

While the simulations in FIGS. 7A-7D were conducted using a conceptual demand curve, a CVR-benefit-based demand curve for the proof-of-concept system is presented in FIGS. 8A-8B for illustrative purposes. In particular, FIG. 8A illustrates a plot of a CVR demand curve (too small to be visible), a supply curve for a partially loaded inverter, and a supply curve for a fully loaded inverter. FIG. 8B illustrates a detail view of the portion of FIG. 8A within box 802, in which the CVR demand curve is visible.

The CVR demand curve shown in FIG. 8B is based on the marginal reduction in energy cost due to a reduced operating voltage, created by consumption of reactive power by solar farm inverters (e.g., loads 610 and 612 of FIG. 6). On the other hand, the marginal cost of acquiring reactive power from a partially loaded inverter, when the inverter does not require curtailment of real power, is much lower than that from the fully loaded inverter. Therefore, the amount of reactive power acquired by market clearing is relatively high (approximately 800 kVAR) as indicated by circle 804 in FIG. 8B. The quantity of reactive power cleared in the market depends on the marginal benefit of CVR, which is a function of different factors (e.g., reduction in operating voltage by consumption of reactive power, amount of voltage-dependent load in the distribution network, and variation of line loss with change in voltage). In the depicted example, the local energy market operator's spot price data for the concerned node is used to calculate the bulk energy costs. Supply curves constructed using Equations (1)-(4) set forth above and the local utility's tariff data are overlaid on the CVR demand curve. The dashed and solid supply curves correspond to fully loaded and partially loaded inverters, respectively.

Overlaying the supply and demand curves reveals the economic value that CVR could achieve against the cost of reactive power to accomplish the voltage needed for CVR. In the depicted example, for a fully loaded inverter, the marginal cost of acquiring reactive power increases very steeply in comparison to the marginal CVR benefit, and hence, only a fraction of the available reactive power capacity is cleared in the market (<100 kVAR, as indicated by circle 806 in FIG. 8B). On the other hand, the marginal cost of acquiring reactive power from a partially loaded inverter, when the inverter does not require curtailment of real power, is much lower than that from the fully loaded inverter. Therefore, the amount of reactive power acquired by market clearing is relatively high (approximately 800 kVAR) as indicated by circle 804. The quantity of reactive power cleared in the market depends on the marginal benefit of CVR, which is a function of different factors (e.g., reduction in operating voltage by consuming reactive power, amount of voltage dependent load in the network, and variation of line loss with change in voltage). These benefits, and hence the resulting demand curves, will be situationally unique.

XII. CVR Use Case

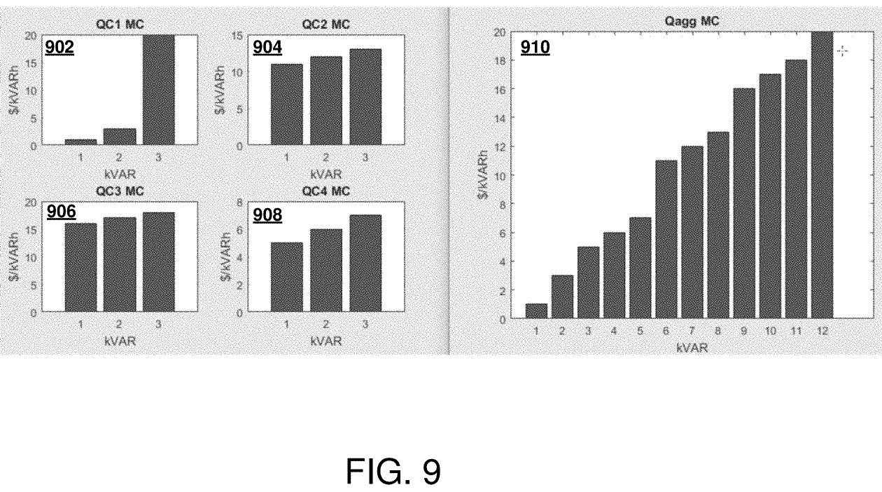

FIG. 9 illustrates graphs used in an exemplary approach for constructing an aggregate supply curve for reactive power. While the approach is described in the context of a CVR use case, it can be applied to other use cases, including voltage optimization.

As in the proof-of-concept system, supply curves for individual inverter assets are available. However, using individual supply curves, and hence performing separate market clearing, would require the decoupling of the CVR benefit. Reactive power absorbed/provided by a given inverter can change voltage in the whole feeder to varying degrees. While power flow Jacobian matrices could theoretically estimate the change in voltage at all of the feeder nodes for a given level of reactive power by a given inverter, using the Jacobian will increase the complexity and hence the computational burden of the process.

In one approach, an aggregate supply curve can be constructed by sorting the pairs of reactive power quantity and marginal price for individual supply curves in ascending order of marginal price. This process is illustrated in FIG. 9 using respective individual supply curves from four assets. Graphs 902, 904, 906, and 908 of FIG. 9 are bar graphs of seller P-Q pairs representing offers from assets QC1, QC2, QC3, and QC4, respectively. The offers can be offers to source or sink reactive power during an upcoming finite time period (e.g., 15 minutes). As shown, each of these assets offers up to 3 kVAR with different marginal costs. The aggregate offer of the four assets would be 12 kVAR, as shown in graph 910. The first 2 kVAR of the aggregate supply curve constitutes offers from the first asset (QC1) because they have the lowest marginal cost (1 and 3 $/kVARh, respectively). The next unit of kVAR is taken from the supply curve of the fourth asset (QC4), which offers the next lowest marginal price (5 $/kVARh). This process is repeated until the maximum of 12 kVAR is reached. Accordingly, an aggregate supply curve can be produced from a plurality of individual supply curves by sorting the seller P-Q pairs from the received supply curves in ascending order of minimum marginal price.

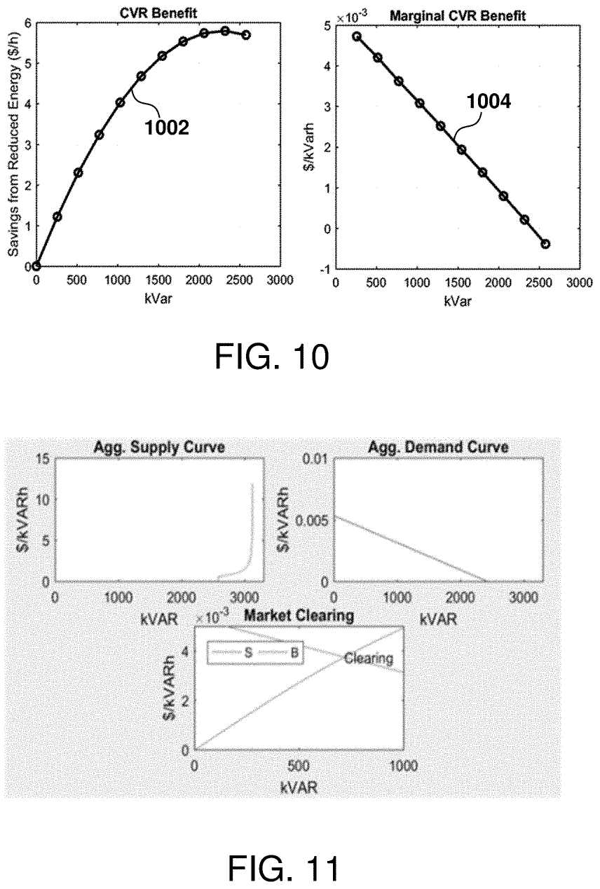

FIG. 10 illustrates an exemplary demand curve 1004 constructed using the marginal hourly savings of electricity cost achieved by performing CVR. To obtain CVR cost curve 1002, a computer simulation can be performed by setting all inverter assets coupled to a feeder to simultaneously sink reactive power from 0% to 100% of their available reactive power capacity (applied in suitable steps, e.g., 10%). The resulting energy savings are plotted against the amount of reactive power to obtain CVR cost curve 1002. CVR demand curve 1004 is then obtained by taking the first derivative of CVR cost curve 1002 with respect to kVAR. The term “available reactive power capacity” refers to the zero-curtailment portion of the inverters' apparent power capacity, where the marginal cost of reactive power is determined using the real power loss in the inverter circuit. While the non-zero-curtailment portion is not considered here, because of the much higher marginal cost of reactive power relative to the marginal benefit, it can optionally be incorporated with the analysis.

FIG. 11 illustrates the results of the computer simulation discussed above regarding FIG. 10. In this example, a market clearing simulation is performed by determining the intersection point of an aggregate supply curve (e.g., as determined via the approach shown in FIG. 9) and the CVR demand curve for each finite time period (market period) under consideration. Individual asset supply curves are constructed considering real power outputs from PV arrays and ESSs, as applicable, using the approach described in Section IX. The amount of reactive power to be dispatched by each inverter asset is determined from its contribution to the amount of market-cleared reactive power obtained from the aggregate supply curve. In the depicted example, the CVR benefit is at such a level that at the cleared price, a reasonable amount of reactive power (e.g., 700 kVAR) could be procured. In other examples, however, the CVR benefit may be so low that the amount of reactive power acquired by the demand curve does not produce a significantly visible voltage reduction. This observation could be related to two aspects: one is the relatively small amount of voltage reduction achieved by reactive power consumption due to stiffness of the feeder under study; the other is the portion of voltage-dependent loads in the feeder.

XIII. Voltage Management Planning and Assessment Tool

Since many use cases can be implicitly described in terms of voltage profiles (e.g., pushing a voltage profile down could create a CVR effect, while increasing voltage could provide voltage support during a peak load condition), one way to perform cost/benefit analysis of different reactive power related use cases would be to determine the cost of achieving a “desired” voltage profile by controlling reactive power that corresponds to the use case under consideration. This approach is implemented herein in the form of voltage management planning and assessment tools. These tools can be used to analyze the cost and benefit of voltage management for different use cases by engaging distribution network assets, as well as to assess the feasibility of deploying a transactive mechanism to implement the use cases.

Voltage management planning and assessment tools can be implemented in a computing environment, e.g., a software application. Such tools can be configured to receive a plurality of inputs. The inputs can include a computer model of at least a portion of a power distribution network (suitable for detailed power flow analysis). For example, a computer model of a portion of a power distribution network can be received as an input by the voltage management planning and assessment tool. In some examples, the computer model can originate as a self-contained study (SXST) file, which is then converted into a GridLAB-D format before being provided to the voltage management planning and assessment tool.

In addition to the computer model, inputs received by the voltage management planning and assessment tool can include a load profile, asset information (e.g., capability curves), the utility's tariff, and the wholesale electricity price at the relevant node. The inputs can further include user inputs, such as a time instant, configuration of the assets as reactive power sources or sinks, and the percentage of reactive power capability of each asset to be used. The user inputs can be received via a user interface (e.g., graphical user interface) of the tool. In some examples, the utility tariff and/or wholesale energy price can be input by the user.

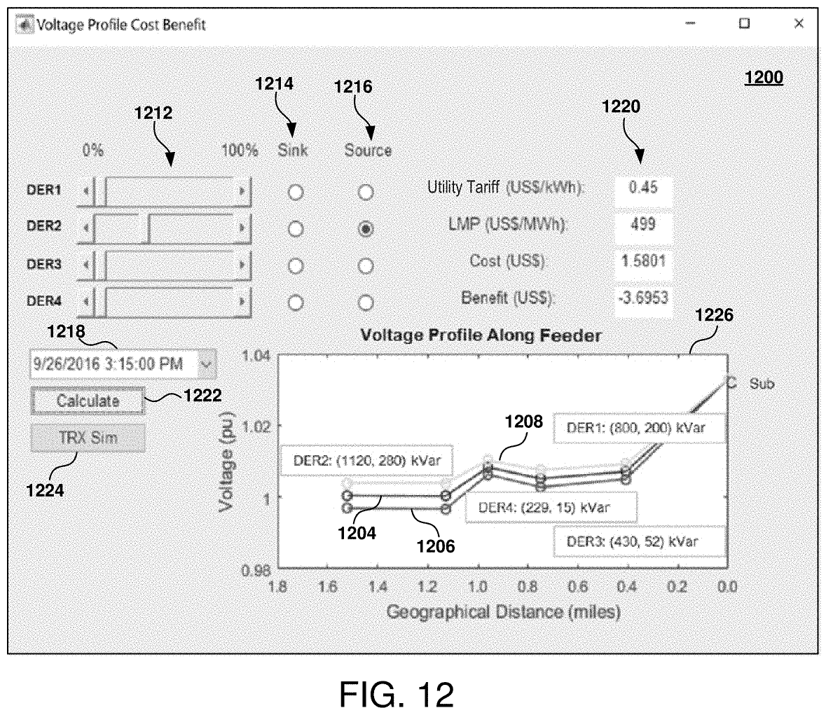

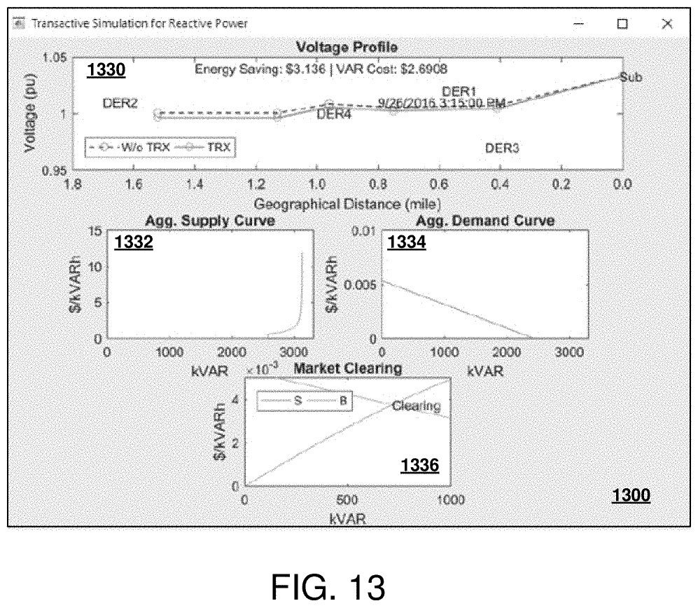

A screenshot of a graphical user interface (GUI) 1200 of an exemplary voltage management planning and assessment tool is shown in FIG. 12. The tool is configured to perform power flow analysis and provide voltage profiles resulting from the specified reactive power control configurations of the assets (e.g., operate as source or sink, percentage of reactive power) connected to the feeder. In some examples, the tool includes also additional GUIs; for example, as described below with reference to FIG. 13, the tool can include a GUI 1300 for displaying detailed transaction simulation results.

The GUI 1200 includes a plurality of fields for receiving user inputs. In the depicted example, GUI 1200 includes four reactive power percentage slider buttons 1212. Each slider button represents a DER coupled to the feeder being modeled and can be adjusted via user manipulation to vary a percentage of the reactive power capacity of the inverter to be used to source or sink reactive power in the simulation. GUI 1200 further includes, for each of the DERs, a radio button 1214 labeled “Sink” and a radio button 1216 labeled “Source.” A dropdown menu 1218 allows the user to input a specified time to simulate, which may include a date (e.g., day, month, and year) and a time of day. In other examples, a different mode of input may be used for the specified time (e.g., the user can type in the date and time or select it in another way). Optionally, the GUI can also include a field to receive user input regarding a duration of a time period to simulate (e.g., 5 minutes, 10 minutes, 15 minutes, etc.), where the time period begins at the specified date and time.

The GUI can further include a plurality of fields 1220. In the depicted example, fields 1220 include an “Utility Tariff” window, an “LMP” window, a “Cost” window, and a “Benefit” window. The “Utility Tariff” and “LMP” windows can display values populated by the tool based on corresponding inputs received by the tool. In other examples, however, these windows can be fields populated via user input. Further, the “Cost” and “Benefit” windows can display values populated by the tool after the tool performs calculations based on user inputs to GUI 1200. For example, GUI 1200 further includes a “Calculate” push button 1222 and a “TRX Sim” push button 1224. The cost of reactive power consumption using DER4, calculated based on the marginal cost curve (supply curve), is also output by the tool, as indicated in the window adjacent to “Cost (US$)”. To compare CVR benefit with its cost, the monetary value of energy saved, calculated using the wholesale electricity price, is also shown, in the window adjacent to “Benefit (US$)”.

After manipulating sliders 1212, selecting a time via dropdown menu 320, and selecting any desired radio buttons 1214 and 1216, a user can press the “Calculate” push button to cause the tool to calculate the cost and benefit associated with these inputs and display them in the “Cost” and “Benefit” windows. Pressing the “Calculate” button can also cause the tool to display a voltage profile along the feeder that will result from the selected inputs in a voltage profile window 1226. In some examples, window 1226 also displays a base case voltage profile 1204, which corresponds to the voltage profile along the feeder if none of the DERs are configured to sink or source any reactive power. Base case voltage profile 1204 can be displayed by default, or by the user clicking the “Calculate” button with the sliders 1212 set to 0%.

In the screenshot shown in FIG. 12, the base case voltage profile 1204 is displayed. Further, as shown, a user has adjusted the slider for DER2 to approximately 30% and clicked the “Source” radio button. The user has also selected 9/26/2016 at 3:15:00 PM as the specified time. This indicates that the user desires to simulate the voltage profile along the feeder at the specified time with DER2 configured to source 30% of its reactive power capacity to the feeder. The user has also clicked the “Calculate” button, causing the tool to display a resulting voltage profile 1208. In voltage profile 1208, the voltage along the feeder is increased as a result of DER2 sourcing reactive power to the feeder.

In the depicted example, window 1226 also displays a previously calculated voltage profile 1206 achieved by configuring DER2 as a reactive power sink at 30% capacity. This situation corresponds to CVR, as the voltage along the length of the feeder is reduced.

In the depicted example, the values in parentheses adjacent to the asset names (e.g., DER1, DER2) in the window 1226 represent the assets' available reactive power capacity (without real power curtailment) and the total reactive power capacity for each asset.

Once the user performs cost/benefit analysis of a desired voltage profile and considers this instance worth exploring for transactive simulation, clicking the “TRX Sim” push button 1224 in user interface 1202 launches a transactive simulation feature of the tool. This can include opening an additional GUI to display the results of the transactive simulation. FIG. 13 illustrates a screenshot 1300 of a GUI for the transactive simulation feature of the tool. In the depicted example, screenshot 1300 displays a graph 1330 of the voltage profile with and without the configurations specified via the user input shown in FIG. 12, as well as a graph 1332 of the aggregate supply curve, a graph 1334 of the aggregate demand curve, and a graph 1336 of market clearing. The energy savings in dollars and the cost of reactive power are also displayed.

Accordingly, the tool has the ability to assess the cost of achieving a desired voltage profile by engaging assets in a given distribution network. It can also model other relevant use cases for applying the transactive mechanism. Two examples of additional use cases are briefly described below.

One potential additional use case for the tool includes providing dynamic hosting capacity for renewable energy resources. Network impacts of high penetration of renewable energy resources into the distribution grid, and the necessity to limit penetration level due to the difficulties with managing those impacts, are recognized issues in the utility industry. Solar PV systems are the most common type of renewable energy resources integrated with distribution grids. Voltage rise and voltage fluctuations caused by solar PV systems are among the major impacts that could lead to limiting the PV penetration level in a given network. If distribution utilities could maintain a desired set of voltage profiles despite solar PV generation, they would be able to increase the solar PV hosting capacity limit. This limit can also be dynamic, to host different levels of PV penetration throughout the day with a varying set of desired voltage profiles. The tool described herein can be extended to support this objective: (a) to determine the cost and benefit of a set of desired voltage profiles that enable higher PV penetration; (b) to create the elements (e.g., supply curves, demand curves) needed to assess the feasibility of creating those voltage profiles through a transactive process.

Another potential additional use case for the tool includes network switching for reconfiguration of network topology. Distribution utilities often encounter situations that require reconfiguration of network topology by switching operations. Closing a normally open switch to supply a portion of the network from an alternative source is a common example of this situation. Depending on the topology and loading level of the network in the switched configuration, the voltage profiles may not always be within the utility's desired range. Inverters in a distribution network may be engaged to provide voltage management services to achieve the utility's desired voltage profiles. However, to assess the feasibility of implementing this use case with a transactive process, cost/benefit analysis of the desired voltage profiles needs to be performed, and the transactive process elements (e.g., supply and demand curve) need to be created. The tool can be extended to serve these purposes.

XIV. Example Method of Determining Reactive Power Clearing Quantity

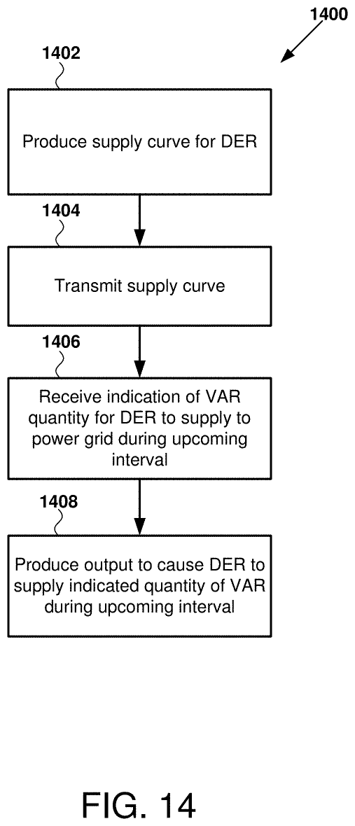

FIG. 14 is a flow chart 1400 outlining an example method of determining a clearing quantity of reactive power to be supplied to a power grid by a DER. For example, a DER controller, such as controller 142 of FIG. 1, can be used to implement the method outlined in FIG. 14.

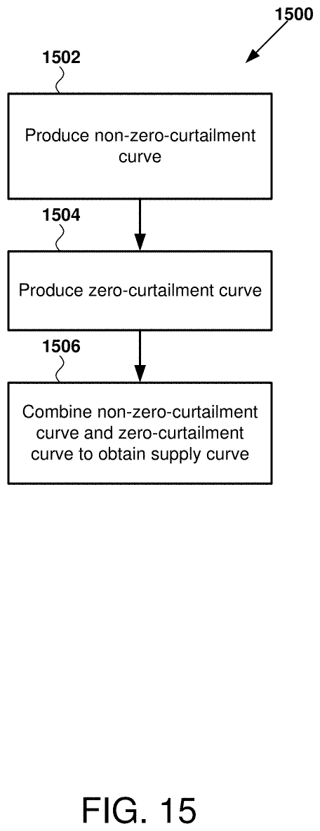

At process block 1402, a supply curve for a DER is produced. The supply curve can be produced by a controller of the DER, such as controller 142 of FIG. 1, in accordance with the method of FIG. 15, for example. In some examples, producing the supply curve includes producing one or more seller P-Q pairs, which can then be plotted on a graph to form a supply curve (e.g., via curve-fitting).

At process block 1404, the supply curve is transmitted. For example, the supply curve can be transmitted by the controller of the DER to a coordinator such as coordinator 180 of FIG. 1, via a network such as network 170 of FIG. 1.

At process block 1406, an indication of a reactive power (VAR) quantity for the DER to supply to the power grid during an upcoming interval is received. For example, the indication may be received from a coordinator via a network. The indication can also optionally specify the start time (e.g., date and time) and duration of the upcoming interval.

At process block 1408, an output is produced to cause the DER to supply the indicated quantity of VAR during an upcoming interval. The output can be produced by the controller of the DER, for example, and can include transmitting a signal which causes the inverter of the DER (e.g., inverter 146 of FIG. 1) to produce the indicated quantity of VAR. In some examples, the signal can be transmitted to the inverter prior to the start of the upcoming interval (e.g., upon receipt of the indication of the VAR quantity to be supplied) and can cause the inverter to produce the indicated quantity of VAR at the start of the upcoming interval. In other examples, however, the signal can be transmitted to the inverter at the start of the upcoming interval, and can cause the inverter to immediately begin producing the indicated quantity of VAR. The signal can optionally include, in addition to the indicated quantity of VAR, an indication of the duration of time during which the inverter should produce the indicated quantity of VAR, and/or an indication of a specific time (e.g., date and time) when the inverter should begin producing the indicated quantity of VAR.

XV. Example Method of Producing a Supply Curve for Reactive Power

FIG. 15 is a flow chart 1500 outlining an example method of producing a supply curve for reactive power. For example, a DER controller, such as controller 142 of FIG. 1, can be used to implement the method outlined in FIG. 15.

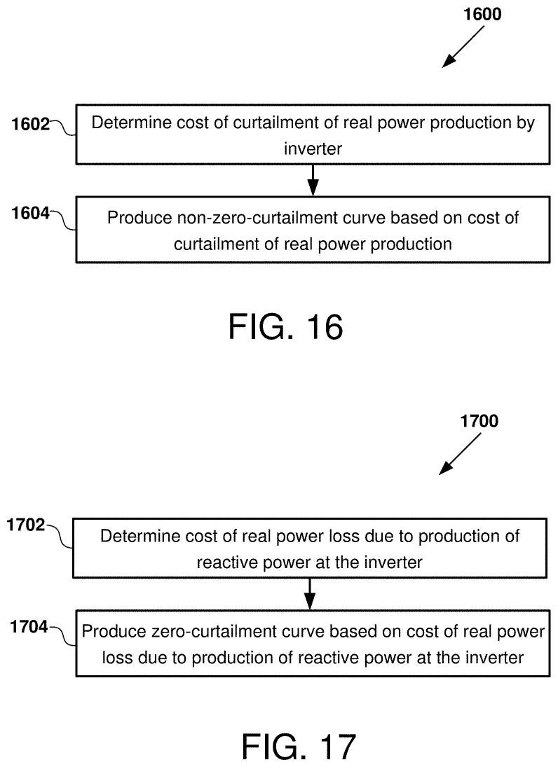

At process block 1502, a non-zero-curtailment curve is produced for a DER. The non-zero-curtailment curve can be produced via the method of FIG. 16, which is discussed below. The non-zero-curtailment curve can reflect the willingness of the owner of the DER to curtail production of real power at the DER (e.g., by an inverter of the DER) in order to produce reactive power to be supplied to the power grid (e.g., to the feeder to which the DER is coupled); this is also referred to as the cost of curtailment. The non-zero-curtailment curve can include a plurality of P-Q pairs, in which the values of Q correspond to quantities of reactive power which, if produced by the DER, would require curtailment of production of real power by the DER. In examples where the DER is not producing real power (e.g., the “Not Loaded” condition shown in FIG. 4C), this step can be omitted.

At process block 1504, a zero-curtailment curve is produced. For example, the zero-curtailment curve can be produced via the method of FIG. 17, which is discussed below. The zero-curtailment curve can reflect the cost of real power loss associated with the production of reactive power to be supplied to the power grid (e.g., to the feeder to which the DER is coupled). The zero-curtailment curve can include a plurality of P-Q pairs, in which the values of Q correspond to quantities of reactive power which, if produced by the DER (e.g., by the inverter of the DER), would not require curtailment of production of real power by the DER. In examples where the entire apparent power capacity of the inverter of the DER is utilized to produce real power (e.g., the “Fully Loaded” condition shown in FIG. 4B), this step can be omitted.

At process block 1506, the non-zero-curtailment and zero-curtailment curves are combined to obtain a supply curve. In some examples, combining the non-zero-curtailment and zero-curtailment curves includes producing a curve from a plurality of P-Q pairs including a first set of P-Q pairs which form the non-zero-curtailment curve and a second set of P-Q pairs which form the zero-curtailment curve, where the first and second sets of P-Q pairs do not share common P-Q pairs.

In examples where the DER (e.g., the inverter of the DER) is not producing real power (e.g., the example shown in FIG. 4C), the zero-curtailment curve is also the supply curve, as there is no non-zero-curtailment curve. Similarly, in examples where the entire apparent power capacity of the inverter is utilized to produce real power (e.g., the example shown in FIG. 4 B), the non-zero-curtailment curve is also the supply curve, as there is no zero-curtailment curve. In contrast, the example supply curve shown in FIG. 4D for a partially loaded inverter, the supply curve includes a portion corresponding to a non-zero-curtailment zone, as well as a portion corresponding to a zero-curtailment zone.

XVI. Example Method of Producing Non-Zero-Curtailment Curve for an Inverter

FIG. 16 is a flow chart 1600 outlining an example method of producing a non-zero-curtailment curve for an inverter. For example, a DER controller, such as controller 142 of FIG. 1, can be used to implement the method outlined in FIG. 16.

At process block 1602, a cost of curtailment of real power production by the inverter is determined. In some examples, the cost of curtailment is determined based at least in part on one or more of the following: an electricity tariff, a quantity of apparent power being produced by the inverter, a quantity of real power being produced by the inverter, or a quantity of reactive power being produced by the inverter. For example, Equation (1) described above can be used to determine the cost of curtailment of real power production. Determining the cost of curtailment of real power production can also include determining the marginal cost of curtailment of real power production, e.g., via Equation (2) described above.

At process block 1604, a non-zero-curtailment curve is produced based on the determined cost of curtailment of real power production. The non-zero-curtailment curve can describe the relationship between the quantity and the marginal cost of curtailment of real power production by an inverter of a DER. An exemplary non-zero-curtailment curve 410 is shown in FIG. 4B. Further, portion 416b of curve 414 of FIG. 4D can be considered a non-zero-curtailment curve.

XVII. Example Method of Producing Zero-Curtailment Curve for Inverter

FIG. 17 is a flow chart 1700 outlining an example method of producing a zero-curtailment curve for an inverter. For example, a DER controller, such as controller 142 of FIG. 1, can be used to implement the method outlined in FIG. 17.

At process block 1702, a cost of real power loss due to production of reactive power at the inverter is determined. In some examples, the cost of real power loss is determined based at least in part on an electricity tariff and an efficiency curve for the inverter (e.g., an efficiency curve for the inverter obtained from a manufacturer of the inverter or obtained via testing of the inverter at different loading levels). For example, Equation (3) described above can be used to determine the cost of real power loss due to production of reactive power at the inverter. Determining the cost of real power loss due to production of reactive power at the inverter can also include determining the marginal cost of real power loss due to production of reactive power at the inverter, e.g., via Equation (4) described above. Inverter wear and tear, increased inverter life cycle costs, etc. can also optionally factor into the determination of the cost of real power loss due to production of reactive power at the inverter.

At process block 1704, a zero-curtailment curve is produced based on the determined cost of real power loss due to production of reactive power at the inverter. The zero-curtailment curve can describe the relationship between the quantity and the marginal cost of real power loss due to production of reactive power at the inverter of a DER. An exemplary zero-curtailment curve 412 is shown in FIG. 4C. Further, portion 416a of curve 414 of FIG. 4D can be considered a zero-curtailment curve.

XVIII. Example Method of Controlling DERs to Supply Clearing Quantity of Reactive Power

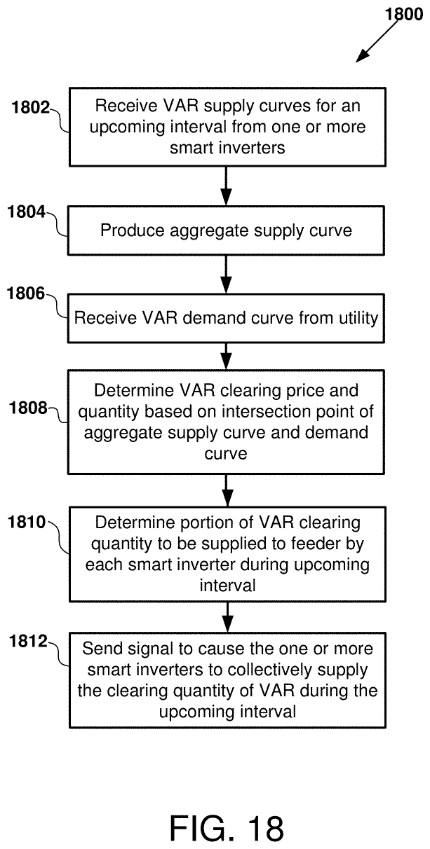

FIG. 18 is a flow chart 1800 outlining an example method of controlling a plurality of DERs to supply a clearing quantity of reactive power (e.g., to one or more feeders of a power distribution network). For example, a coordinator, such as coordinator 180 of FIG. 1, can be used to implement the method outlined in FIG. 18.

At process block 1802, VAR supply curves for an upcoming interval are received from one or more smart inverters. For example, VAR supply curves can be received by the coordinator from respective controllers of the one or more smart inverters, such as controllers 142 and 162 of FIG. 1. Each received VAR supply curve can optionally include a plurality of seller P-Q pairs.

At process block 1804, an aggregate supply curve is produced. The aggregate supply curve can describe the relationship between the quantities of reactive power collectively offered by the one or more smart inverters and the lowest marginal price offered by one of the one or more smart inverters for each quantity. In some examples, the aggregate supply curve is produced by the coordinator by sorting the seller P-Q pairs from the received supply curves in ascending order of minimum marginal price, as described above with reference to FIG. 9.

At process block 1806, a VAR demand curve is received from a utility. For example, a VAR demand curve can be received by the coordinator from an administrator of a utility that operates the power distribution network including the DERs, such as administrator 115 of FIG. 1. The VAR demand curve can optionally include a plurality of buyer P-Q pairs, and can describe the relationship between quantities of reactive power demanded by the utility and marginal prices the utility is willing to pay for the respective quantities of reactive power to be supplied to the power distribution network by the DERs.

At process block 1808, a VAR clearing price and quantity are determined based on an intersection point of the aggregate supply curve and the demand curve, for example as described above with reference to FIG. 4A. The intersection point can alternatively be referred to as the clearing point or market clearing point, and can be specific to an upcoming finite time period or interval. In some examples, the determination is performed by the coordinator. In other examples, however, the administrator of the utility also performs the role of coordinator, including producing the aggregate supply curve and determining the intersection point of the supply and demand curves, and the coordinator can be omitted.

In some examples, the aggregate supply curve and the demand curve will not intersect. In such examples, determining the VAR clearing price and quantity at process block 1808 can include determining that there is no clearing point.

At process block 1810, a portion of the VAR clearing quantity to be supplied to a feeder by each smart inverter during an upcoming interval is determined (e.g., by the coordinator). Assuming that the supply and demand curves do intersect at a clearing point, the determination can be based at least in part on a contribution of the supply curve for the smart inverter to the aggregate supply curve at the clearing point. As an example, referring to the example aggregate supply curve shown in FIG. 9, assume a clearing point at which the clearing price is $18/kVARh and the clearing quantity is 11 kVAR. The marginal price of reactive power offered by DERs QC2, QC3, QC4 is less than or equal to $18/kVARh for quantities up to 3 kVAR. However, the marginal price of reactive power offered by DER QC1 is greater than $18/kVARh for quantities greater than 2 kVAR. Accordingly, in this example, the portion of the VAR clearing quantity to be supplied to the feeder by QC1 is 2 kVAR, and the portion of the VAR clearing quantity to be supplied to the feeder by each of QC2, QC3, and QC4 is 3 kVAR, for a total of 11 kVAR.

At process block 1812, a signal is sent to cause the one or more smart inverters to collectively supply the clearing quantity of VAR during the upcoming interval. This can include the coordinator sending a signal via a network to the controller of each smart inverter that is to supply a portion of the VAR clearing quantity, where the signal specifies the quantity. The signal sent to a given smart inverter can also optionally include the price that will be paid for that quantity of VAR, the date/time at which the upcoming interval during which the smart inverter is to supply that quantity of VAR begins, the duration of the interval, etc. Referring again to an example clearing point where the marginal price is $18/kVARh and the quantity is 11 kVAR, with reference to FIG. 9, the signal sent to the controller of QC1 can instruct QC1 to dispatch (or cause QC1 to dispatch) 2 kVAR to the feeder for the duration of the upcoming interval, whereas the respective signals sent to the controllers of QC2, QC3, and QC4 can instruct the smart inverters to each dispatch (or cause the smart inverters to each dispatch) 3 kVAR to the feeder for the duration of the upcoming interval.

In examples where the demand curve did not intersect with the aggregate supply curve, however, process block 1812 can include sending a signal to cause the one or more smart inverters to refrain from altering their operation in order to dispatch reactive power to the grid during the upcoming interval. The coordinator can then proceed to attempt to obtain market clearing for a different upcoming interval.

XIX. Example Method of Controlling DERs to Supply Clearing Quantity of Reactive Power Determined Based on Demand Curve

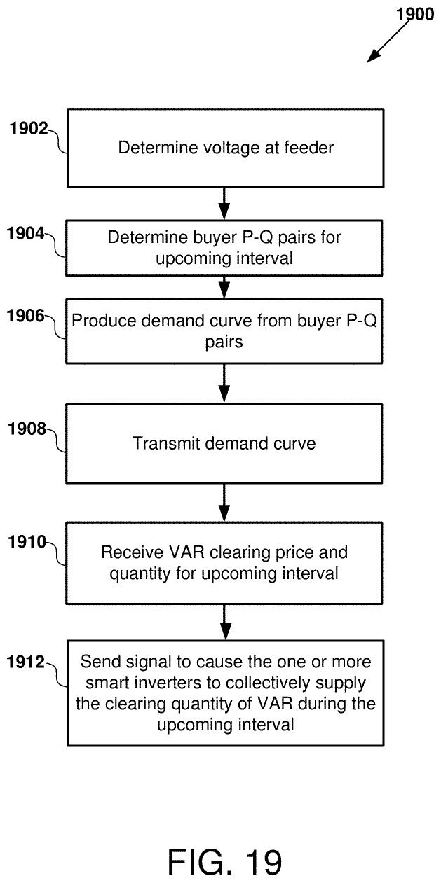

FIG. 19 is a flow chart 1900 outlining an example method of producing a demand curve for reactive power and controlling a plurality of DERs to supply a clearing quantity of reactive power determined based on the demand curve to a power grid. For example, an administrator of a utility, such as administrator 115 of FIG. 1, can be used to implement some or all steps of the method outlined in FIG. 19.

At process block 1902, voltage at a feeder is determined. For example, the administrator can receive a signal from a voltage sensor at the feeder indicating the voltage at the feeder.

At process block 1904, buyer P-Q pairs for an upcoming interval are determined. The buyer P-Q pairs can each indicate a quantity of VAR and a marginal price the utility will pay for that quantity of VAR to be supplied to the feeder during an upcoming interval. In some examples, the buyer P-Q pairs can be determined based at least in part on an extent to which the voltage at the feeder deviates from a reference value. The reference value can be a predetermined reference value corresponding to a desired voltage at the feeder, e.g., a voltage which will reduce energy usage, for example through CVR, while still providing an acceptable level of power to loads coupled to the feeder.

At process block 1906, a demand curve is produced from the determined buyer P-Q pairs. For example, the demand curve can be produced in the manner discussed above with reference to FIGS. 5 and 10.

At process block 1908, the demand curve is transmitted. For example, the demand curve can be transmitted from the administrator of a utility to a coordinator via a network. In examples where the administrator performs the functionality of the coordinator, this step can be omitted.

At process block 1910, a VAR clearing price and quantity are received for the upcoming interval. The VAR clearing price and quantity for the upcoming interval can be determined by a coordinator, e.g., in the manner described above with reference to FIG. 18, and then transmitted by the coordinator to the administrator. The administrator can then use this information for planning purposes. In examples where the administrator serves as the coordinator, however, the VAR clearing price and quantity can be determined by the administrator, rather than received by the administrator.

At process block 1912, a signal is sent to cause the one or more smart inverters to collectively supply the clearing quantity of VAR during the upcoming interval. The signal can be sent by the coordinator or by the administrator. In some examples, a separate signal can be sent to the controller of each smart inverter, where the signal sent to a given smart inverter indicates how much (if any) of the clearing quantity of VAR should be supplied to the feeder by that smart inverter during the upcoming interval. The signal can optionally include further information, such as the start date, time, and duration of the upcoming interval. In some examples, the coordinator or administrator is capable of directly controlling the smart inverter via the signal, to cause the smart inverter to dispatch the desired portion of the clearing quantity of VAR. In other examples, upon receiving the signal, the controller of the smart inverter has the option to refuse to dispatch the desired portion of the clearing quantity of VAR during the upcoming interval.

XX. Example Method of Dispatching DERs to Supply Reactive Power Based on a Market Clearing Simulation

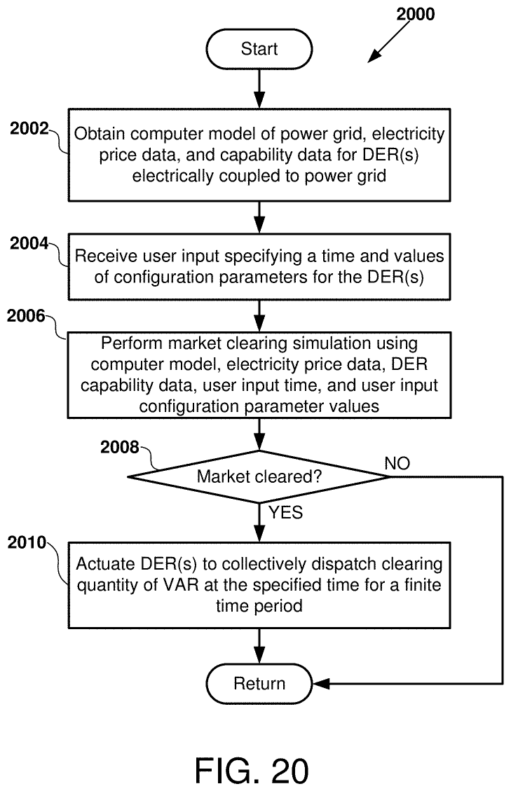

FIG. 20 is a flow chart 2000 outlining an example method of dispatching DERs to supply reactive power based on a market clearing simulation for reactive power performed using a voltage management planning and assessment tool (e.g., the tool discussed in Section XIII above). The tool can be implemented by a software application, e.g., software 280 of FIG. 2, and can be used in conjunction with power distribution network shown in FIG. 1.

At process block 2002, a computer model of a power grid, electricity price data, and capability data for one or more DERs electrically coupled to a power grid are obtained. For example, a computer model of the power grid can be obtained from the utility operating the power grid, or from another entity. The electricity price data can include the wholesale electricity price at a specified time, or during a specified finite time period. The wholesale electricity price can alternatively be referred to as the location marginal price (LMP), which can be set by the utility operating the power grid or another entity. The capability data for the one or more DERs can include capability curves and/or efficiency curves of inverters of the DERs and/or mathematical functions describing such curves. Exemplary inverter capability curves 408 are shown in FIGS. 4B-4D, for example.

In other examples, the computer model of the power grid, the electricity price data, and/or the capability data can be obtained via user input. In such examples, the GUI of the voltage management planning and assessment tool can include additional fields in which a user can input this information (e.g., by uploading files containing computer models or other data, or by entering text constituting the data).

At process block 2004, user input is received which specifies a time as well as values of configuration parameters for the DER(s). For example, a user can specify the start time of an upcoming finite time period to be simulated by selecting from a dropdown menu, such as dropdown menu 318 of FIG. 12. The user input specifying a time can also specify a date. The user input specifying values of configuration parameters for the DER(s) can include user input specifying, for a given DER, whether to configure the DER as a reactive power source or sink, a portion (e.g., percentage) of a reactive power capacity of the inverter to be used. In the example GUI shown in FIG. 12, the portion of the reactive power capacity of the inverter to be used to source or sink reactive power in the simulation can be input via user manipulation of sliders 1212, whereas the user can select either the radio button 1214 or 1216 for each DER to indicate whether to simulate the DER sinking or sourcing the specified portion of its reactive power capacity.

At process block 2006, a market clearing simulation is performed using the computer model, electricity price data, capability data, user input time, and user input configuration parameter values. For example, a software application implementing the voltage management planning and assessment tool can perform the market clearing simulation responsive to a user clicking a button on a GUI such as the “TRX Sim” push button 1224 of FIG. 12. Performing the market clearing simulation can include determining a clearing price and quantity of reactive power, e.g., as discussed above with reference to FIG. 4A.

At process block 2008, it is determined whether the market has cleared. For example, the results of the market clearing simulation (e.g., as displayed in the GUI shown in FIG. 13) may include a plot of the aggregate supply curve and demand curve in which the curves do not intersect, indicating that the market has not cleared. If the answer at process block 2008 is NO, the method returns.

Otherwise, if the answer at process block 2008 is YES, indicating that the aggregate supply and demand curves do intersect, the method proceeds to process block 2010. At process block 2010, the DER(s) are actuated to collectively dispatch a clearing quantity of VAR at the specified time for a finite time period. This can include a user of the tool initiating the sending of signals to controllers of one or more of the DERs that cause the DERs to collectively dispatch the clearing quantity of VAR at the specified time for a finite time period. In other examples, the software application implementing the tool can enable a user (e.g., a user associated with the utility) to enact the simulated voltage profile management scenario by pushing a button, which in turn sends signals to one or more DERs via a network that cause the DERs to collectively supply the clearing quantity of reactive power at the specified time.

XXI. Example Method of Performing Market Clearing Simulation Using Voltage Management Planning and Assessment Tool

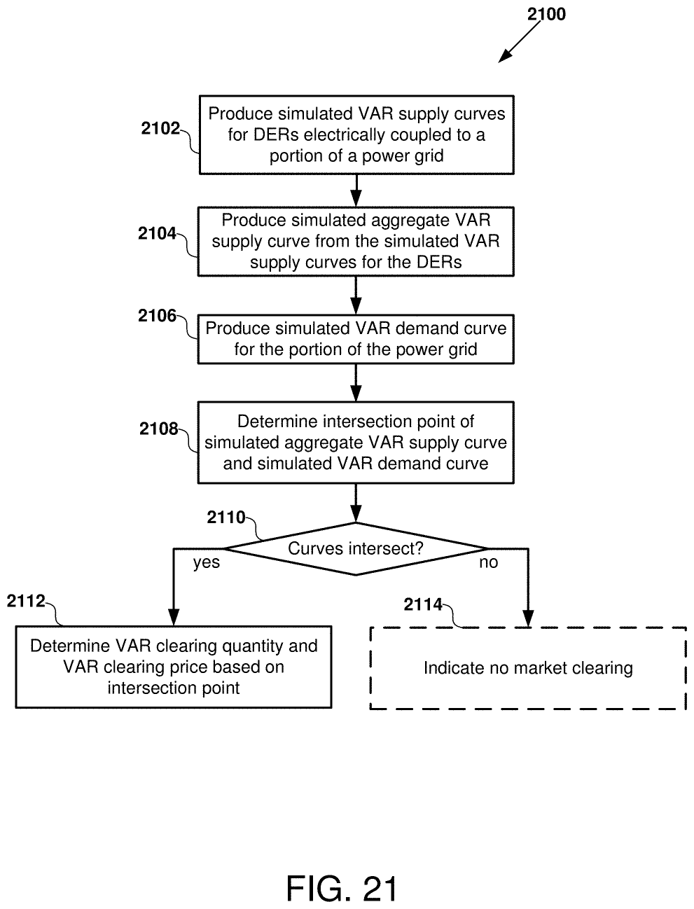

FIG. 21 is a flow chart 2100 outlining an example method of performing a market clearing simulation for reactive power using a voltage management planning and assessment tool (e.g., the tool discussed in Section XIII above). The tool can be implemented by a software application, e.g., software 280 of FIG. 2, and can be used in conjunction with power distribution network shown in FIG. 1.

At process block 2102, simulated VAR supply curves for DERs electrically coupled to a portion of a power grid are produced. For example, the tool can produce the simulated VAR supply curves based on inputs, including user inputs received via a GUI (e.g., the GUI shown in FIG. 12) and other inputs such as a computer model of the portion of the power grid to which the DERs are coupled. The simulated VAR supply curves can be produced in the manner described above with reference to FIG. 15, for example.

At process block 2104, a simulated aggregate VAR supply curve is produced from the simulated VAR supply for the DERs. For example, the tool can produce the simulated aggregate VAR supply curve in the manner described above with reference to FIG. 9.

At process block 2106, a simulated VAR demand curve is produced for the portion of the power grid. For example, the tool can produce the simulated VAR demand curve based on inputs provided to the tool, including the current voltage profile of the feeder and/or predicted voltage profile at the feeder at the time period being simulated. In other examples, the VAR demand curve for a given interval can be received at the tool from an administrator of the utility.

At process block 2108, an intersection point of the simulated aggregate VAR supply curve and the simulated VAR demand curve is determined, e.g., in the manner described above with reference to FIG. 18.

At process block 2110, it is determined whether the simulated aggregate VAR supply curve and the simulated VAR demand curve intersect. If the answer at process block 2110 is YES, indicating that the curves do intersect, the method proceeds to process block 2112.

At process block 2112, a VAR clearing quantity and a VAR clearing price are determined based on the intersection point, e.g., in the manner described above with reference to FIG. 18.

Otherwise, if the answer at process block 2110 is NO, indicating that the curves do not intersect, the method proceeds to process block 2114. At process block 2114, the method optionally includes indicating no market clearing, e.g., via a GUI such as the GUI shown in FIG. 13.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method, comprising:
producing a supply curve for a distributed energy resource (DER) electrically coupled to a utility-operated power grid based at least in part on a present loading level of an inverter of the DER, the supply curve relating quantities of reactive power the DER will supply to the power grid during an upcoming interval to corresponding marginal prices the DER will charge to supply the reactive power;
transmitting a message indicating the supply curve;
responsive to the transmitting, receiving an indication of a quantity of reactive power for the DER to supply to the power grid during the upcoming interval, the indicated quantity being based at least in part on the transmitted supply curve and a demand curve relating quantities of reactive power demanded by the utility to be supplied to the power grid during the upcoming interval to corresponding marginal prices the utility will pay for the reactive power; and
producing an output to cause the DER to supply the indicated quantity of reactive power to the power grid during the upcoming interval.

2. The method of claim 1, wherein the present loading level of the inverter reflects a quantity of real power being produced by the inverter relative to an apparent power capacity of the inverter.

3. The method of claim 2, wherein producing the supply curve comprises producing a non-zero-curtailment curve corresponding to a portion of the apparent power capacity of the inverter being used for real power production, producing a zero-curtailment curve corresponding to a portion of the apparent power capacity of the inverter not being used for real power production, and combining the non-zero-curtailment and zero-curtailment curves to obtain a supply curve.

4. The method of claim 3, wherein the supply curve describes a relationship between the quantity and marginal price of reactive power offered by the DER.

5. The method of claim 3, wherein the producing of the non-zero-curtailment curve is based at least in part on a cost of curtailment of real power production by the inverter, and wherein the cost of curtailment is determined based at least in part on one or more of the following: an electricity tariff, a quantity of apparent power being produced by the inverter, a quantity of real power being produced by the inverter, or a quantity of reactive power being produced by the inverter.

6. The method of claim 3, wherein the producing of the zero-curtailment curve is based at least in part on a cost of real power loss due to production of reactive power at the inverter.

7. The method of claim 6, wherein the cost of real power loss due to production of reactive power at the inverter is determined based at least in part on an electricity tariff and an efficiency curve for the inverter.

8. The method of claim 1, wherein the DER comprises a rooftop photovoltaic system electrically coupled to the inverter or an electrical energy storage system electrically coupled to the inverter.

9. A controller for the DER, comprising:
a network adapter;
one or more processors configured to produce a signal to cause the inverter to source a desired quantity of reactive power to the power grid or sink a desired quantity of reactive power from the power grid; and
one or more computer-readable storage media storing computer-executable instructions that when executed by the processors, cause the controller to perform the method of claim 1.

10. A method, comprising:
receiving, from each of one or more smart inverters electrically coupled to a feeder of a power grid, a message indicating a supply curve for reactive power for an upcoming interval;
producing an aggregate supply curve from the received supply curves;
receiving, from a utility operating the power grid, a message indicating a demand curve for reactive power;
determining coordinates of an intersection point of the demand curve with the aggregate supply curve, the coordinates indicating a clearing price for reactive power during the upcoming interval and a clearing quantity of reactive power to be supplied to the feeder by the one or more smart inverters during the upcoming interval;
determining, for each of the one or more smart inverters, a portion of the clearing quantity of reactive power to be supplied to the feeder by the smart inverter during the upcoming interval; and
sending a signal to cause the one or more smart inverters to collectively supply the clearing quantity of reactive power to the feeder during the upcoming interval in exchange for payment by the utility at the clearing price.

11. The method of claim 10, wherein the supply curve for reactive power for each smart inverter comprises a plurality of seller price-quantity pairs, each seller price-quantity pair indicating a quantity of reactive power and a minimum marginal price the smart inverter will accept to supply that quantity of reactive power during the upcoming interval.

12. The method of claim 11, wherein producing the aggregate supply curve from the received supply curves comprises sorting the seller price-quantity pairs from the received supply curves in ascending order of minimum marginal price.

13. The method of claim 12, wherein for at least one of the one or more smart inverters, the determination of the portion of the clearing quantity of reactive power to be supplied to the feeder by the smart inverter during the upcoming interval is based at least in part on a contribution of the supply curve for the smart inverter to the aggregate supply curve at the intersection point.

14. A coordinator, comprising:
a network adapter;
one or more processors; and
one or more computer-readable storage media storing computer-executable instructions that, when executed by the one or more processors, cause the coordinator to perform the method of claim 10.

15. A method, comprising:
determining a voltage at a feeder of a power grid operated by a utility;
determining a plurality of buyer price-quantity pairs based at least in part on an extent to which the voltage at the feeder deviates from a reference value, each buyer price-quantity pair indicating a quantity of reactive power and a marginal price the utility will pay for that quantity of reactive power to be supplied to the feeder during an upcoming interval;
producing a demand curve from the buyer price-quantity pairs;
transmitting a message indicating the demand curve;
responsive to the transmitting, receiving an indication of a clearing price and a clearing quantity of reactive power for the upcoming interval, the clearing price and clearing quantity being based at least in part on the transmitted demand curve and an aggregate supply curve relating quantities of reactive power that one or more smart inverters electrically coupled to the feeder will supply to the feeder during the upcoming interval to corresponding marginal prices the one or more smart inverters will charge to supply the quantities of reactive power during the upcoming interval; and
transmitting a signal that causes the one or more smart inverters to collectively supply the clearing quantity of reactive power to the feeder during the upcoming interval.

16. The method of claim 15, wherein the marginal price the utility will pay for a given quantity of reactive power increases as the voltage at the feeder deviates further from a reference value.

17. The method of claim 15, wherein for at least one buyer price-quantity pair, the marginal price the utility will pay for the quantity of reactive power is determined based at least in part on an estimated financial impact of the feeder not being supplied the quantity of reactive power during the upcoming interval.

18. The method of claim 15, wherein for at least one buyer price-quantity pair, the marginal price the utility will pay for the quantity of reactive power is determined based at least in part on an estimated cost for the feeder to receive the quantity of reactive power from a source other than the one or more smart inverters.

19. The method of claim 18, wherein the source other than the one or more inverters is a capacitor bank electrically coupled to the feeder.

20. The method of claim 15, wherein for at least one buyer price-quantity pair, the quantity of reactive power is positive or negative.

21. A method, comprising:
obtaining a computer model of a portion of a power grid;
obtaining electricity price data;
obtaining capability data for one or more distributed energy resources (DERs) electrically coupled to the portion of the power grid;
receiving input specifying a time;
receiving input specifying values of configuration parameters for the one or more DERs, the configuration parameters for a given DER including whether to configure the DER as a reactive power source or sink, and a value indicating a portion of a reactive power capacity of the DER to be used;
performing a clearing simulation for the specified time based at least in part on the computer model, the electricity price data, the capability data, and the specified configuration parameter values;
producing clearing simulation results including a clearing quantity of reactive power and a clearing price of reactive power; and
responsive to the producing of the clearing simulation results, configuring the one or more DERs in accordance with the specified configuration parameter values and actuating the one or more DERs to dispatch the clearing quantity of reactive power to the portion of the power grid for a finite time period beginning at the specified time.

22. The method of claim 21, wherein the computer model of the portion of the power grid comprises a load profile of a feeder electrically coupled to the one or more DERs.

23. The method of claim 21, wherein the electricity price data comprises one or more of the following: a tariff set by an electric power distribution utility operating the power grid, or a wholesale electricity price.

24. The method of claim 21, wherein the capability data for the one or more DERs comprises respective capability curves for the one or more DERs.

25. The method of claim 21, wherein performing the clearing simulation comprises:
producing a simulated reactive power supply curve for each DER;
producing a simulated aggregate reactive power supply curve from the simulated reactive power supply curves;
producing a simulated reactive power demand curve for the portion of the power grid; and
determining an intersection point of the simulated aggregate reactive power supply curve and the simulated reactive power demand curve;
wherein the clearing quantity of reactive power and the clearing price of reactive power are determined based at least in part on the intersection point.

26. The method of claim 25, wherein the clearing simulation is performed in response to receiving a user request to display simulation results, and wherein the method further comprises:
responsive to receiving the user request, producing a graph of a hypothetical voltage profile along a feeder of the power grid at the specified time with the one or more DERs engaged to source or sink the clearing quantity of reactive power in accordance with the specified configuration parameters, wherein the one or more DERs are electrically coupled to the feeder; and
displaying the graph.

27. The method of claim 25, wherein the clearing simulation is performed in response to receiving a user request to calculate a monetary cost and a monetary benefit associated with engaging the one or more DERs to source or sink the clearing quantity of reactive power in accordance with the specified configuration parameters, and wherein the method further comprises:
responsive to receiving the user request, calculating the monetary cost and the monetary benefit based at least in part on the clearing quantity, the clearing price, and the electricity price data; and
displaying the estimated monetary cost and monetary benefit.

28. A system, comprising:
a power grid operated by a utility;
an administrator controller associated with the utility and configured to produce a demand curve relating quantities of reactive power demanded by the utility to be supplied to the power grid during an upcoming interval to corresponding marginal prices the utility will pay for the reactive power, and transmit a message indicating the demand curve;
one or more distributed energy resources (DERs) having respective controllers, the one or more DERs being electrically coupled to a feeder of the power grid and operable to source reactive power to the feeder or sink reactive power from the feeder, and the controller for each DER being configured to produce a supply curve relating quantities of reactive power offered by the DER for the upcoming interval to corresponding marginal prices the DER will accept in exchange for supplying the reactive power to the power grid during the upcoming interval, and transmit a message indicating the supply curve; and
a coordinator controller configured to receive the message indicating the demand curve from the administrator controller and the messages indicating the supply curves from the respective controllers of the one or more DERs, determine a clearing price and clearing quantity for reactive power for the upcoming interval based at least in part on the demand curve and the supply curves, and send a signal that causes the one or more DERs to collectively dispatch the clearing quantity of reactive power to the feeder during the upcoming interval.

29. The system of claim 28, wherein the administrator controller is configured to produce the demand curve based at least in part on one or more of the following: an estimated financial impact of the feeder not being supplied the demanded quantity of reactive power during the upcoming interval, or an estimated cost for the feeder to receive the demanded quantity of reactive power from a source other than the one or more DERs.

30. The system of claim 28, wherein the controller for each DER is configured to produce the supply curve for the DER based at least in part on a loading level of the DER.
